(19) United States
(12) Patent Application Publication
(10) Pub. No.: US 2024/0151736 A1
(43) Pub. Date: May 9, 2024

(54) Apparatus for Multiple Sample Analysis

(71) Applicant: Essenlix Corporation, Monmouth Junction, NJ (US)

(72) Inventors: Stephen Y. CHOU, Princeton, NJ (US); Hua TAN, Princeton Junction, NJ (US); Yanjun WANG, Somerset, NJ (US); Wei DING, Princeton, NJ (US)

(73) Assignee: Essenlix Corporation, Monmouth Junction, NJ (US)

(21) Appl. No.: 18/411,418

(22) Filed: Jan. 12, 2024

Related U.S. Application Data
(63) Continuation of application No. PCT/US22/36879, filed on Jul. 12, 2022.
(60) Provisional application No. 63/220,990, filed on Jul. 12, 2021.

(51) Int. Cl. G01N 35/00; G01N 35/02

(52) U.S. Cl. CPC G01N 35/00069; G01N 35/021; G01N 2035/00148

(57) ABSTRACT

The disclosure provides an apparatus for high throughput analysis of samples and a method of making an assay card and performing an assay using the apparatus. The apparatus can include a transporter to position and advance a first plate of the QMAX card, a first dispenser to deposit a sample on the first plate, a second dispenser to dispense a reagent to contact the sample, a press to compress the sample between the first and second plates of the QMAX card into a uniformly thick layer, and an imager to image the uniformly thick layer.

### CROSS-REFERENCE TO RELATED APPLICATION

This application is a bypass continuation of PCT/US22/36879 filed on Jul. 12, 2022, which claims priority to the US provisional application with Ser. No. 63/220,990, filed Jul. 12, 2021, the entire contents of which is incorporated herein by reference.

### FIELD

The present invention is related to the field of bio/chemical sampling, sensing, assays and applications, more specifically to an apparatus and system for high throughput analysis of multiple samples and executing an assay.

### BACKGROUND

In many bio/chemical sensing and testing chemical reactions, and other processes, there are needs for devices, apparatus, systems, and methods that can accelerate the bio/chemical sensing and testing process, quantify parameters to simplify the sample collection and measurement processes, handle samples with small volumes, allow an entire assay to be performed in less than a minute, allow an assay to be performed by a simple system, allow non-professionals to perform the assay by themselves, and allow a test result to be communicated locally, remotely, or wirelessly to different relevant parties. There are also needs to analyze multiple samples at fast speeds and on a continuous basis in an automated high throughput system that forms the assay and executes the assay in situ. The present invention relates to the methods, devices, and systems that address these needs.

### SUMMARY

The present invention provides an apparatus for automatic assaying multiple samples. The apparatus comprises sample test cartridges which are the QMAX cards, a transporter for transporting the test cartridges, a sample applying dispenser, an optional reagent applying dispenser, a press, and an imager.

The QMAX card comprises a first plate and a second plate. In an embodiment, the first plate is a substrate and is relatively rigid (e.g., a PMMA plate of a thickness of 0.5 mm or more) while the second plate is flexible. The thickness of the rigid plate times the Young's modulus is 1 GPa-mm or higher in one embodiment, 1.5 GPa-mm or higher in another embodiment, 3 GPa-mm or higher in another embodiment, and 4.5 GPa-mm or higher in another embodiment. In an embodiment, the first plate includes, on its inner surface, a sample contact area for contacting a sample that contains or is suspected to contain an analyte. In an embodiment, the second plate is relatively flexible. In an embodiment, the second plate is a film. The first and second plates are movable relative to each other into different configurations, including an open configuration and a closed configuration. In the open configuration, the two plates are partially or completely separated apart, allowing the sample to be deposited on one or both of the plates. In the closed configuration that is configured after the sample is deposited in the open configuration, at least part of the sample is compressed by the two plates into a layer of highly uniform thickness, and the uniform thickness of the layer is confined by the inner surfaces of the two plates and is regulated by the plates and spacers disposed on one or both of the two plates.

The QMAX card can be configured in two modes, A and B. In mode A, the first and second plates are connected by a hinge, and thereby the two plates can rotate relative to each other into the open and the closed configuration via the hinge. In mode B, there is no hinge joining the first plate with the second plate, and the first and second plates are two separate plates without connecting them together in the open configuration.

The QMAX Card has two opposite surfaces which can hold a sample in between. The two surfaces are formed by one of the following methods: (1) a QMAX Card where sample is applied between the two plates when the QMAX Card adopts mode A; and (2) a substrate and a film where the sample is applied between the substrate and film when the QMAX card adopts mode B.

When the QMAX Card adopts mode A, the QMAX Card receives a sample. The transporter positions and advances the QMAX Card. In an embodiment, a substrate feeder can be used to place the QMAX Card on the transporter. In an embodiment, there is a QMAX Card opener that opens the QMAX Card from a close configuration into an open configuration. The sample dispenser deposits the sample onto the QMAX card, for example, on the substrate plate of the QMAX Card, in the open configuration. In an embodiment, the optional reagent applying dispenser dispenses a reagent to contact the sample (if the reagent is not applied on the QMAX card already). The press can be used to close the QMAX Card from open configuration into a closed configuration and compresses the sample between the QMAX cover film and substrate into a uniformly thick layer. The imager images the uniformly thick layer.

When the QMAX card adopts mode B, a first plate of the QMAX card is place on the transporter, a sample is dispensed on one of the two plates of the QMAX card, and then the two plates are pressed into a closed configuration, followed by an imaging for analysis of the sample. In an embodiment, the sample is dispensed on the first plate.

When a substrate and a film is used, the substrate receives a sample. The transporter positions and advances the substrate. The substrate feeder places the substrate on the transporter. The first dispenser deposits the sample on the substrate. The second dispenser dispenses a reagent to contact the sample. The film covers the sample. A film feeder or robotic arm can be used to place the film on the substrate. In an embodiment, the press compresses the sample between the film and the substrate into a uniformly thick layer. The imager images the uniformly thick layer.

In some embodiments, the present invention provides a system of making an assay card and executing an assay wherein the substrate feeder places the substrate on the transporter in a first station to form a base layer of an assay card, the first dispenser deposits a sample on the substrate in a second station, the second dispenser dispenses a reagent to contact the sample on the substrate in the second station, the film feeder places a film on the substrate to cover the sample and form a cover layer of the assay card in a third station, the press uniformly compresses the sample between the substrate and the film into a uniformly thick layer to form the assay card in the third station, the imager images the uniformly thick layer to obtain an image for analysis in a fourth station, and the transporter positions and advances the substrate along each of the stations.

In some embodiments, the present invention provides a method of making an assay card and executing an assay including placing a substrate on a transporter with the substrate feeder to form a base layer of an assay card, depositing a sample on the substrate with a first dispenser, contacting the reagent and the sample with a second dispenser, placing a film on the substrate with a film feeder to cover the sample and form a cover layer of the assay card, uniformly pressing the film against the substrate to compress the sample between the substrate and the film into a uniformly thick layer and form the assay card, imaging the sample with an imager to obtain an image, and analyzing the image with an analyzer to determine a property of the sample.

In some embodiments, the method includes forming the base layer in a first station, depositing the sample on the substrate in a second station, contacting the reagent and the sample in the second station, forming the cover layer and assay card in a third station, and imaging the sample is in a fourth station.

### BRIEF DESCRIPTION OF THE DRAWINGS

A skilled artisan will understand that the drawings, described below, are for illustration purposes only. In some Figures, the drawings are in scale. For clarity purposes, some elements are enlarged when illustrated in the Figures. It should be noted that the Figures do not intend to show the elements in strict proportion. The dimensions of the elements should be delineated from the descriptions herein provided and incorporated by reference. The drawings are not intended to limit the scope of the present invention in any way.

FIG. 1A shows a schematic view of one example of a system for sample analysis having a linear transporter.

FIG. 1B schematically shows the transportation of a QMAX card on a transporter.

FIG. 1C schematically shows the system for sample analysis in accordance with an embodiment.

FIG. 2A shows in the QMAX card in mode (A) and mode (B), in accordance with some embodiments.

FIG. 2B shows a perspective view of a system for sample analysis having a linear transporter in operation in accordance with an embodiment.

FIG. 2C shows a perspective view of a system for sample analysis having a linear transporter in operation in accordance with an embodiment.

FIG. 2D shows a schematical view of a system for sample analysis having a linear transporter in operation in accordance with an embodiment.

FIG. 3A shows a perspective view of one example of a system for sample analysis having a circular transporter.

FIG. 3B shows a perspective view of one example of a system for sample analysis having a belt transporter and a picker.

FIG. 4 shows a side view of the system of FIG. 3A.

FIG. 5 shows a top plan view of the system of FIG. 3A.

FIG. 6 shows the transporter of the system of FIG. 3 positioning the assembled assay card at multiple positions and angles with respect to an imager (not shown) point to provide the imager with multiple fields of views of different areas of the assay card and the sample during imaging.

FIG. 7 shows the transporter of the system of FIG. 6.

### DETAILED DESCRIPTION

The following detailed description illustrates certain embodiments of the invention by way of example and not by way of limitation. If any, the section headings and any subtitles used herein are for organizational purposes only and are not to be construed as limiting the subject matter described in any way. The contents under a section heading and/or subtitle are not limited to the section heading and/or subtitle, but apply to the entire description of the present invention.

The citation of any publication is for its disclosure prior to the filing date and should not be construed as an admission that the present claims are not entitled to antedate such publication by virtue of prior invention. Further, the dates of publication provided can be different from the actual publication dates which need to be independently confirmed.

### Definitions

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described.

The term “Field of View” or “FOV” refers to the extent of the observable world that is seen at any given moment. In other words, the “field of view” is the area that is observable by an imager, or the solid angle through which an imager is sensitive to electromagnetic radiation.

The term “Air Cushion Press” and/or “ACP” refers to utilizing a gas (or fluid) to press a mold and substrate against each other. ACP has a number of advantages over solid parallel-plate press (SPP): (1) ACP uses conformable gas (or fluid) layers to eliminate any direct contact between the solid plates and samples (mold and/or substrate), and, hence, removes any effects related to the imperfection of the solid plates; (2) because the pressurized gas is conformal to the mold and substrate, regardless of their backside shapes or any dust particles on the backside, the pressure will be uniform everywhere over the entire imprint area; (3) isotropically applied gas pressure eliminates lateral shift or rotation between the mold and substrate, reducing damage to the mold and prolonging mold lifetime; (4) ACP keeps the pressure on the mold and substrate at a preset value rather than the total force as in SSP, eliminating the “hot” spots (local high-pressure regions caused by small contact areas under a constant force) in SSP that damage the mold and the substrate; and (5) because a pressurized gas has much smaller thermal mass than a solid plate, when combined with radiative direct heating to the samples and convection cooling, ACP shortens the thermal imprint time by orders of magnitude (e.g., ACP can complete the nanoimprint process in seconds rather than in tens of minutes as in SPP).

The terms “CROF Card (or card)”, “COF Card”, “QMAX-Card”, “Q-Card”, “CROF device”, “COF device”, “QMAX-device”, “CROF plates”, “COF plates”, and “QMAX-plates” are interchangeable, except that in some embodiments, the COF card does not comprise spacers; and the terms refer to a device that comprises a first plate and a second plate that are movable relative to each other into different configurations (including an open configuration and a closed configuration), and that comprises spacers (except some embodiments of the COF card) that regulate the spacing between the plates. The term “X-plate” can refer to one of the two plates in a CROF card, wherein the spacers are fixed to this plate. More descriptions of the COF Card, CROF Card, and X-plate are given in the provisional application serial nos. 62/456,065, filed on Feb. 7, 2017, which is incorporated herein in its entirety for all purposes.

The term “open configuration” of the two plates in a QMAX process means a configuration in which the two plates are either partially or completely separated apart and the spacing between the plates is not regulated by the spacers.

The term “closed configuration” of the two plates in a QMAX process means a configuration in which the plates are facing each other, the spacers and a relevant volume of the sample are between the plates, the relevant spacing between the plates, and thus the thickness of the relevant volume of the sample, is regulated by the plates and the spacers, wherein the relevant volume is at least a portion of an entire volume of the sample.

The term “a sample thickness is regulated by the plate and the spacers” in a QMAX process means that for a give condition of the plates, the sample, the spacer, and the plate compressing method, the thickness of at least a port of the sample at the closed configuration of the plates can be predetermined from the properties of the spacers and the plate.

The term “inner surface” or “sample surface” of a plate in a QMAX card can refer to the surface of the plate that touches the sample, while the other surface (that does not touch the sample) of the plate is termed “outer surface”.

The term “height” or “thickness” of an object in a QMAX process can refer to, unless specifically stated, the dimension of the object that is in the direction normal to a surface of the plate. For example, spacer height is the dimension of the spacer in the direction normal to a surface of the plate, and the spacer height and the spacer thickness means the same thing.

The term “area” of an object in a QMAX process can refer to, unless specifically stated, the area of the object that is parallel to a surface of the plate. For example, spacer area is the area of the spacer that is parallel to a surface of the plate.

The term QMAX card can refer the device that perform a QMAX (e.g., CROF) process on a sample, and have or not have a hinge that connect the two plates.

The term “QMAX card with a hinge and “QMAX card” are interchangeable.

The term “angle self-maintain”, “angle self-maintaining”, or “rotation angle self-maintaining” can refer to the property of the hinge, which substantially maintains an angle between the two plates, after an external force that moves the plates from an initial angle into the angle is removed from the plates.

The term “a spacer has a predetermined height” and “spacers have a predetermined inter-spacer distance” means, respectively, that the value of the spacer height and the inter spacer distance is known prior to a QMAX process. It is not predetermined, if the value of the spacer height and the inter-spacer distance is not known prior to a QMAX process. For example, in the case that beads are sprayed on a plate as spacers, where beads are landed at random locations of the plate, the inter-spacer distance is not predetermined. Another example of not predetermined inter spacer distance is that the spacers move during a QMAX processes.

The term “a spacer is fixed on its respective plate” in a QMAX process means that the spacer is attached to a location of a plate and the attachment to that location is maintained during a QMAX (i.e., the location of the spacer on respective plate does not change) process. An example of “a spacer is fixed with its respective plate” is that a spacer is monolithically made of one piece of material of the plate, and the location of the spacer relative to the plate surface does not change during the QMAX process. An example of “a spacer is not fixed with its respective plate” is that a spacer is glued to a plate by an adhesive, but during a use of the plate, during the QMAX process, the adhesive cannot hold the spacer at its original location on the plate surface and the spacer moves away from its original location on the plate surface.

As will be apparent to those of skill in the art upon reading this disclosure, each of the individual embodiments described and illustrated herein has discrete components and features which can be readily separated from or combined with the features of any of the other several embodiments without departing from the scope or spirit of the present teachings. Any recited method can be carried out in the order of events recited or in any other order which is logically possible. One skilled artisan will appreciate that the present invention is not limited in its application to the details of construction, the arrangements of components, category selections, weightings, pre-determined signal limits, or the steps set forth in the description or drawings herein. The invention is capable of other embodiments and of being practiced or being carried out in many different ways.

Working Principles and Certain Embodiments

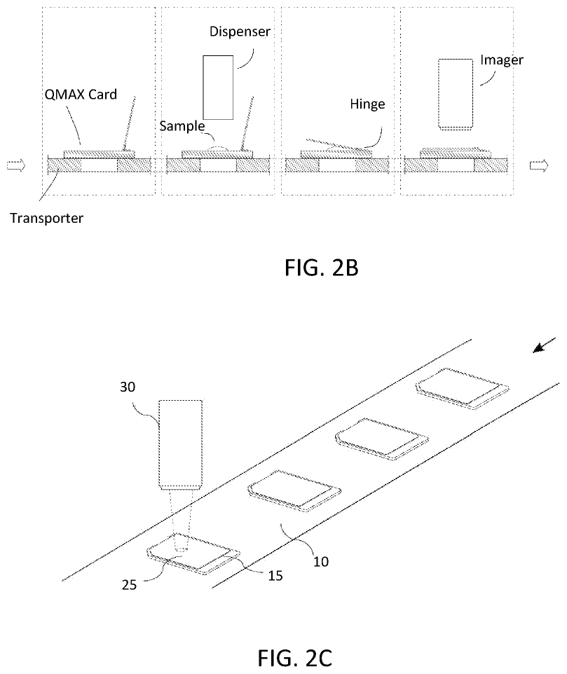

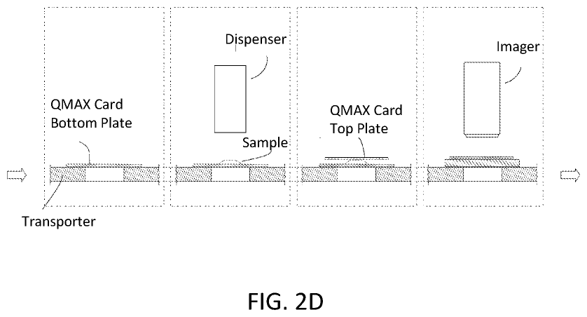

FIG. 2A shows the QMAX in two modes: A and B, in accordance with some embodiments. In mode A, the first and second plates are connected by a hinge, and thereby the two plates can rotate relative to each other into the open and the closed configuration via the hinge. In mode B, there is no hinge joining the first plate with the second plate, and the first and second plates are two separate plates without being connected together in the open configuration.

FIG. 2A also schematically illustrates a non-limiting embodiment of the QMAX card in an open and close configuration, respectively. The QMAX-Card can comprise a first plate 210, a second plate 220. In some embodiments, the first plate 210 is a substrate. In some embodiments, the second plate 220 is a cover film. The first plate 210 comprises an inner surface 211 and an outer surface 212. The second plate 220 comprises an inner surface 221 and an outer surface 222. Spacers (not shown in FIG. 2A) may be disposed of on one or both inner surfaces 211 or 221. In some embodiments, the spacers are disposed on the inner surface 211 of the first plate 210. The spacers can regulate the spacing between the first plate 210 and the second plate 220, thereby regulating the thickness of a sample sandwiched therebetween.

In an embodiment, a hinge 203 that is a joint is disposed between the first plate 210 and the second plate 220. The first plate 210 and the second plate 220 can rotate relative to each other via the hinge, forming different configurations, including the open and closed configurations. The open configuration is a configuration in which the two plates 210 and 220 are either partially or completely separated apart, as shown in FIG. 2A. The open configuration can provide sufficient spacing between the two plates 210 and 220, which allows a user to deposit or load a sample 20 on the inner surfaces 211 or 221. In some embodiments, the sample 20 is deposited onto a sample area on the inner surface 211 of the first plate 210. In some embodiments, after the sample is deposited, the second plate 220 can be rotated to stack on the first plate 210 to form the closed configuration in which the two plates 210 and 220 face each other.

A drop of a sample 20 (e.g., blood) is dropped on a sample contacting area at the inner surface of 211 or 221 surface. A press device can then be used to press the first plate 210 so that the two plates of the QMAX card are closed to compress the sample into a thin layer.

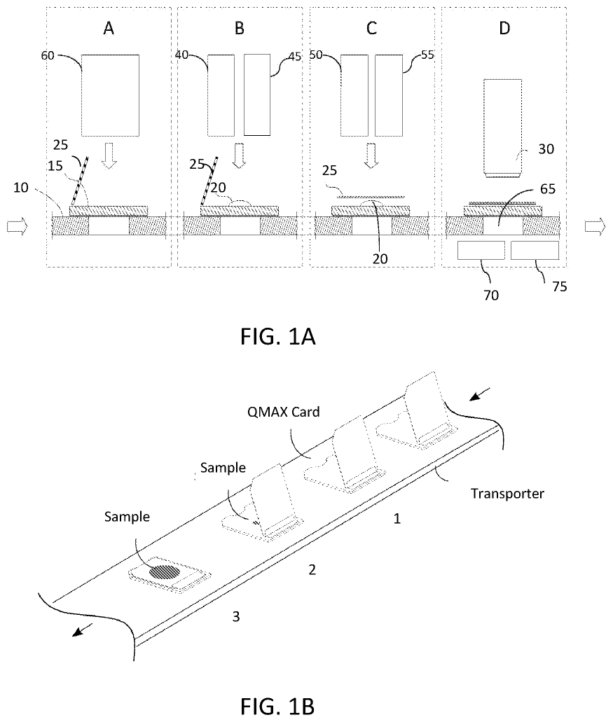

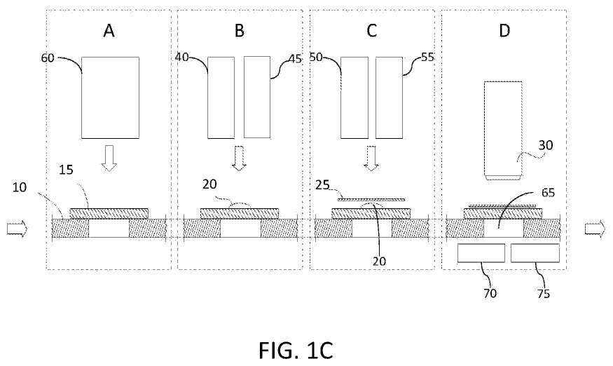

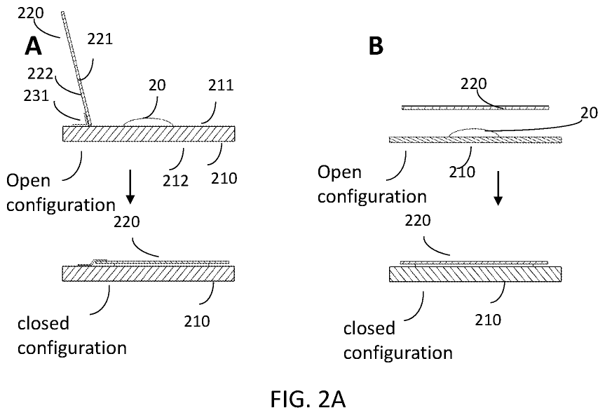

In some embodiments, multiple QMAX cards in an open configuration are arranged on a transporter, as shown in FIG. 1B. The transporter transports each QMAX card onto a dispenser, and then the dispenser dispenses a sample into the QMAX card. The transporter then transports the QMAX card containing sample to a press device. The press device then presses the QMAX cards into the closed configuration. In some embodiments, the transporter can automatically and continuously transport QMAX card to dispenser, press device, and imagers to achieve high-throughput analysis of samples.

In some embodiment, the QMAX card does not have the hinge as shown in FIG. 2A(B), a feeder or robotic arm instead of the press device picks the second plate 220 and puts it on the first plate 210. The press device then compresses the sample disposed, for example, on the first plate 210 into a thin layer.

It is appreciated that the hinge and other structures of the QMAX-Card can have other suitable designs or arrangements than those discussed above.

In an embodiment, at least a part of the QMAX cards, for example the first plate, are transported by the transporter. In an embodiment, the transporter can transport the QMAX cards in an open configuration to a sample applying dispenser so that the sample applying dispenser can dispense the sample into the QMAX cards. In an embodiment, an additional reagent applying dispenser can be used to dispense a reagent into the QMAX card. In an embodiment, the transporter transports the QMAX cards containing the sample to a press so that the press presses the two plates into a closed configuration. In some embodiments, the press device is a device that can press, for example, the second plate so that the second plate rotates toward the first plate into the closed configuration. In an embodiment, the press device is a robotic arm that can pick up the second plate and put it on the first plate and then compress a sample disposed therebetween into a thin layer.

FIGS. 1A, 1B, and 2B show a system for sample analysis in accordance with some embodiments of the present invention. The system can provide the automated high through-put formation of an assay and execution of the assay in situ. In some embodiments, the system provides an apparatus comprising a QMAX card including a first plate 15 and a second plate 25 for receiving a sample, a transporter 10 for positioning and advancing the QMAX card, a feeder 60 for placing the QMAX card on the transporter 10, a first dispenser 40 for depositing a sample 20 on the first plate 15 of the QMAX card, an optional second dispenser 45 for dispensing a reagent for contacting the sample 20, a press device 55 for pressing the second plate 25 to compress the sample 20 disposed between the second plate 25 and the first 15 into a uniformly thick layer, and an imager 30 for imaging the uniformly thick layer. In an embodiment, first dispenser 40 deposits the sample 20 onto the first plate 15 prior to the second dispenser 45 depositing the reagent onto the first plate 15. In another embodiment, the second dispenser 45 deposits the reagent onto the first plate 15 prior to first dispenser 40 depositing the sample 20 onto the first plate 15. In yet another embodiment, the second dispenser 45 deposits the reagent onto the second plate 25 prior to the press device press 50 to press the second plate 25 toward the first plate 15 to compress the sample 20.

FIG. 2B shows a schematic side view of system under modes A for sample analysis. The transporter is used to position and advance QMAX Cards. The imager images the uniformly thick layer.

FIG. 1B shows a system for sample analysis according to one embodiment of the present invention. The transporter positions and advances the QMAX Cards. There is a QMAX Card opener that opens the QMAX Card from a close configuration into an open configuration. At station 1, QMAX Card forms an open position with one plate rotating around a hinge. At station 2, a sample is deposited by a dispenser on the bottom plate of the QMAX Card. An optional reagent applying dispenser dispenses a reagent to contact the sample (if the reagent is not applied on the QMAX card already). At station 3, a press closes the QMAX Card from the open configuration into a closed configuration and compresses the sample between the two QMAX plates into a uniformly thick layer. The imager images the uniformly thick layer.

In an embodiment, the system includes a docking apparatus 70 for positioning the QMAX card in a stationary position for inspection. In another embodiment, the system includes a moveable stage for moving the QMAX card in a vertical and/or horizontal direction during imaging to increase the optical observation area of the sample. For example, during imaging the moveable stage can move the QMAX card, and hence the sample 20, to different locations relative to the imager 30, such that different areas of the sample fall under the FoV of the imager. In one embodiment, the moveable stage is disposed on the transporter 10. In another embodiment, the moveable stage is a motorized stage.

In some embodiment, the feeder 60 is a QMAX card feeder that can place QMAX card onto the transporter 10.

FIGS. 1C, 2C, and 2D show a system for sample analysis according to one embodiment of the present invention in accordance with another embodiment. FIGS. 2B-2D shows a perspective view of the system for sample analysis according to one embodiment of the preset invention. The system can provide the automated high through-put formation of an assay and execution of the assay in situ. In some embodiments, the system provides an apparatus comprising a substrate 15 of a QMAX card for receiving a sample, a transporter 10 for positioning and advancing the substrate 15, a substrate feeder 60 for placing the substrate 15 on the transporter 10, a first dispenser 40 for depositing a sample 20 on the substrate 15, an optional second dispenser 45 for dispensing a reagent for contacting the sample 20, a film 25 of the QMAX card for covering the sample 20, a film feeder 50 for placing the film 25 on the sample 20, a press 55 for compressing the sample 20 between the film 25 and the substrate 15 into a uniformly thick layer, and an imager 30 for imaging the uniformly thick layer. In one embodiment, first dispenser 40 deposits the sample 20 onto the substrate 15 prior to the second dispenser 45 depositing the reagent onto the substrate 15. In another embodiment, the second dispenser 45 deposits the reagent onto the substrate 15 prior to first dispenser 40 depositing the sample 20 onto the substrate 15. In yet another embodiment, the second dispenser 45 deposits the reagent onto the film 25 prior to film feeder 50 placing the film 25 on the sample 20.

In one embodiment, the system includes a docking apparatus 70 for positioning the substrate 15 in a stationary position for inspection. In another embodiment, the system includes a moveable stage for moving the substrate 15 in a vertical and/or horizontal direction during imaging to increase the optical observation area of the sample. For example, during imaging the moveable stage can move the substrate 15, and hence the sample 20, to different locations relative to the imager 30, such that different areas of the sample fall under the FoV of the imager. In one embodiment, the moveable stage is disposed on the transporter 10. In another embodiment, the moveable stage is a motorized stage.

FIG. 2D shows a schematic side view of system under modes B for sample analysis. The QMAX Card bottom plate is positioned and advanced by the transporter. A sample is deposited on the bottom plate. The top plate is applied. A press compresses the sample between the two plates to form a uniformly thick layer. The imager images the uniformly thick layer.

In some embodiments of the system, the feeder 60 is a substrate feeder that places the QMAX card or the substrate 15 on the transporter 10, the first dispenser 40 deposits the sample 20 on the substrate, the second dispenser 45 dispenses a reagent to contact the sample 20 on the substrate 15, the film feeder 50 places a film 25 on the substrate 15 to cover the sample 20, the press 55 uniformly compresses the sample 20 between the substrate 15 and the film 25 into a uniformly thick layer, and the imager 30 images the uniformly thick layer. In one embodiment, the docking apparatus 70 positions the substrate 15 in the stationary position prior to the imager 30 imaging the uniformly thick layer in order to improve image quality. In one embodiment, the docking apparatus 70 positions the substrate 15 in a stationary position within the system. In another embodiment, the docking apparatus 70 positions the substrate 15 in a stationary position outside of the system. The docking apparatus 70 is positioned adjacent to the transporter 10, such that the 10 transporter and the substrate 15 are positioned between the imager 30 and the docking apparatus 70.

In some embodiments, the substrate feeder 60 places the substrate 15 on the transporter 10 in a first station A, the first dispenser 40 deposits a sample 20 on the substrate 15 in a second station B, the second dispenser 45 dispenses a reagent to contact the sample 20 on the substrate 15 in the second station B, the film feeder 50 places a film 25 on the substrate 15 to cover the sample 20 in a third station C, the press 55 uniformly compresses the sample 20 between the substrate 15 and the film 25 into a uniformly thick layer in the third station C, the imager 30 images the uniformly thick layer in a fourth station D, and the transporter 10 positions and advances the substrate 15 along each of the stations A, B, C, D. In one embodiment, the docking apparatus 70 positions the substrate 15 in the stationary position prior to the imager 30 imaging the uniformly thick layer in the fourth station D. Once, the uniformly thick layer of sample 20 is imaged by the imager 30, the docking apparatus 70 releases the substrate 15 such that substrate may move with the transporter 10.

In some embodiments, the present invention provides a method of making an assay card and executing an assay including placing the substrate 15 on the transporter 10 with the substrate feeder 60, depositing the sample 20 on the substrate 15 with a first dispenser 40, contacting a reagent and the sample 20 with the second dispenser 45, placing the film 25 on the substrate 15 with the film feeder 50 to cover the sample 20, uniformly pressing the film 25 against the substrate with the press 55 to compress the sample 20 between the substrate 15 and the film 25 into a uniformly thick layer, imaging the sample 20 with the imager 30 to obtain an image, and analyzing the image with an analyzer to determine a property of the sample 20. In one embodiment, the method includes positioning the substrate 15 in a stationary position with the docking apparatus 70 prior to the imager 30 imaging the uniformly thick layer.

In one embodiment, placing of the substrate 15 on the transporter occurs in the first station A, depositing of the sample 20 on the substrate 15 with the first dispenser 40 occurs in the second station B, contacting of the reagent with the sample 20 with the second dispenser 45 occurs in the second station B, placing of the film 25 on the substrate 15 with the film feeder 50 to cover the sample 20 occurs in the third station C, uniform pressing of the film 25 against the substrate 15 to compress the sample 20 between the substrate 15 and the film 25 into a uniformly thick layer occurs in the third station C, and imaging the sample 20 with the imager 30 to obtain an image occurs in the fourth station D. In one embodiment, positioning the substrate 15 in a stationary position with the docking apparatus 70 prior to the imager 30 imaging the uniformly thick layer occurs in the fourth station D.

In some embodiments, placement of substrate 15 onto the transporter 10 forms a base layer of an assay card. In one embodiment, substrate 15 is the base layer. In an embodiment, placement of the film 25 onto the sample 20 forms the cover layer of the assay card. In one embodiment, film 25 is the cover layer. Compression of sample 20 by press 55 between the base layer, e.g., the substrate 15, and the cover layer, e.g., the film 25, forms the assay card. Compression of the sample compresses sample 20 into a uniformly thick layer between the substrate 15 and the film 25. Imaging the uniformly thick layer of sample 20 obtains images for further inspection, processing and analyzing.

In some embodiments, the transporter 10 includes an opening 65 for allowing the imager 30 to image the sample 20 through the transporter 10. In an embodiment, the opening 65 is disposed adjacent the substrate 15 when the substrate has been placed onto the transported 10. In other embodiments, the opening 65 is disposed immediately below the substrate 15 when the substrate has been placed onto the transported 10. In one embodiment, the opening 65 is aligned with a center of the substrate 15. In another embodiment, the opening 65 is larger than a field of view of the imager 30.

In some embodiments, transporter 10 can include a conveyor belt for linear transportation of the substrate 15. In an embodiment, the conveyor belt includes a carrier plate for removably receiving the substrate 15 on a surface thereof. In one embodiment, the carrier plate includes a recess for retaining the substrate in place. In some embodiments, transporter 10 includes a rail system for linearly advancing the substrate 15.

The imager 30 includes at least one light source. In one embodiment, the light source is integral to the imager 30. In another embodiment, light source 75 is apart from the imager and positioned adjacent the transporter 10, such that the transporter 10 and the substrate 15 are positioned between the imager 30 and the light source 75, as shown in FIG. 1. In this embodiment, the light source 75 illuminates the substrate 15 and sample 20 through the opening 65. In one embodiment, the imager 30 includes a microscope with a lens for inspecting and viewing a sample 20 and image collection. In another embodiment, the imager 30 includes an array of image sensors which can collect multiple images at the same time at different locations of the sample 20. In yet another embodiment, the imager 30 includes at least one camera having a field of view. In alternative embodiments, the imager 30 includes multiple cameras each having a field of view allowing the imager 30 to image multiple fields of views of the sample 20 simultaneously. In some embodiments, the imager 30 is positioned such that the substrate 15 is disposed between the imager 30 and the transporter 10. In other embodiments, the imager 30 is positioned such that the transporter 10 is disposed between the imager 30 and the substrate 15. In this embodiment, the imager 30 can image the sample 20 through the opening of the transporter 10. In one embodiment, the imager 30 is oriented with respect to the substrate 15 at an angle from 60 to 120 degrees. In another embodiment, the imager 30 is normal to the substrate 15. In some embodiments, the docking apparatus 70 comprises a mechanical arm. In some embodiments, the imager does not scan the essay card having a sample. Avoiding scanning of the discrete assay card having a sample avoids lengthy imager scanning routines, saves data collection and analysis time, and reduces the time to obtain reportable results.

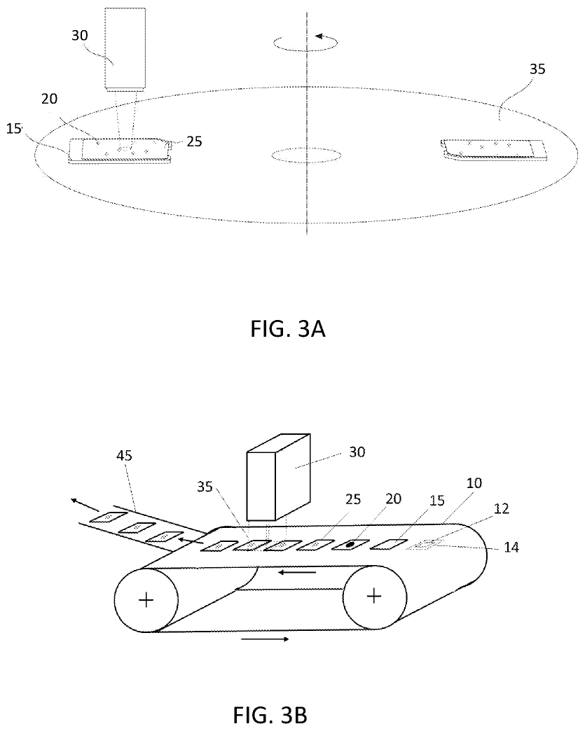

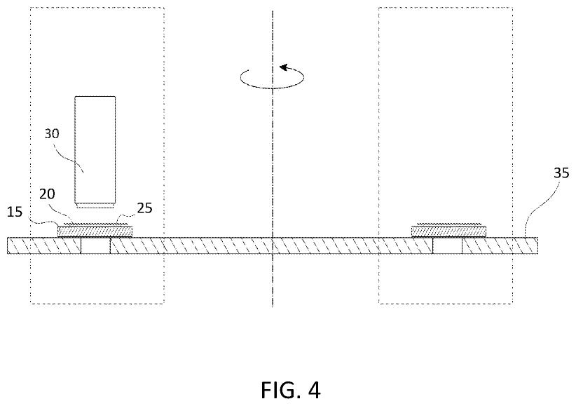

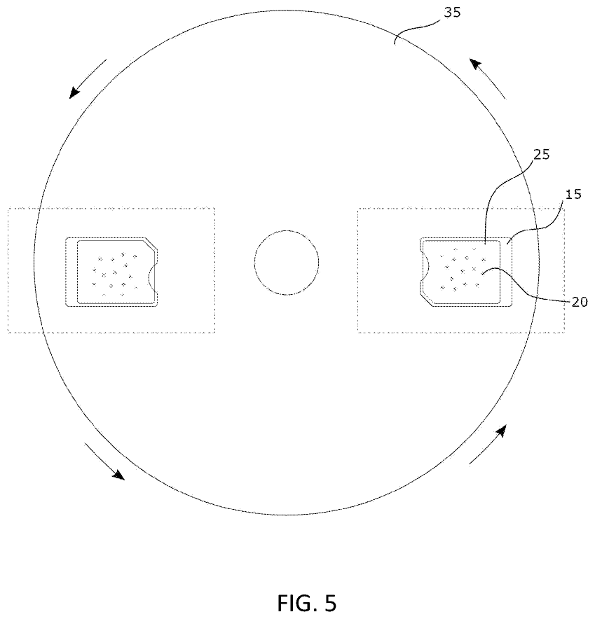

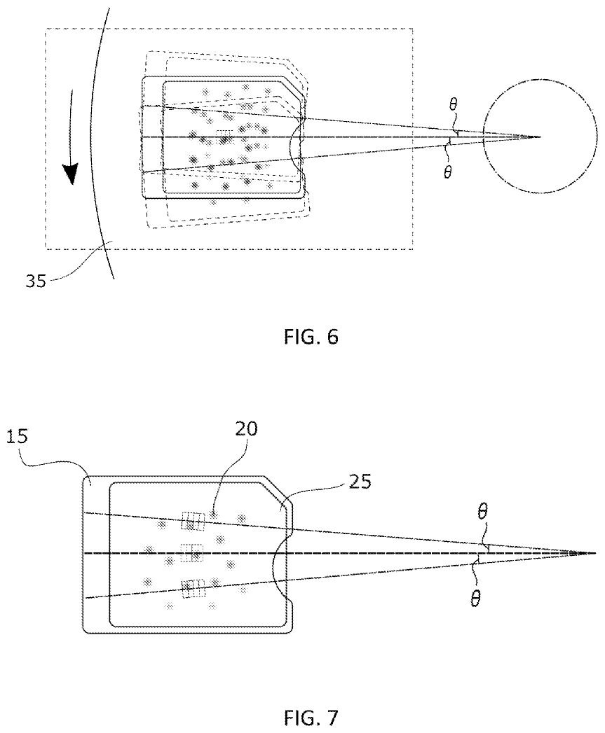

Referring now to FIGS. 3-5, FIG. 3 shows a perspective view of the system for sample analysis according to another embodiment of the present invention. FIG. 4 shows a side view of the system for sample analysis according to another embodiment of the present invention. FIG. 5 shows a top plan view of the system for sample analysis according to one embodiment of the present invention. In some embodiments, the transporter 10 comprises a rotatable plate 35 for annular rotation or advancement of the substrate 15 around a central axis. Annular advancement of substrate 15 increases the optical observation area of the sample 15. For example, in one embodiment, the rotatable plate 35 positions the substrate 15 at an angle θ with respect to the imager 30 so as to provide the imager 30 a field of view of an area of the sample 20 to image, as shown in FIGS. 6 and 7. For example, this area can be a predetermined area of the sample 20, a random area of the sample 20, or a fixed area of the sample 20. In one embodiment, the rotatable plate 35 positions the substrate 15 at an angle with respect to the imager 30 in the fourth station D. In other embodiments, the rotatable plate 35 positions the substrate 15 at a plurality of angles with respect to the imager 30 to provide the imager multiple fields of views of different areas of the sample 20 to image, for example, to obtain multiple images of the sample 20 along different angles θ, as shown in FIGS. 6 and 7. Each angle θ forms a different field of view for the imager 30 to acquire an image. In some embodiments, the rotatable plate 35 includes a recess for removably receiving and retaining the substrate 15 in place. In other embodiments, the rotatable plate 35 includes a carrier plate for removably receiving the substrate 15. In one embodiment, the carrier plate includes a recess for retaining the substrate 15 in place.

FIG. 3A shows a perspective view of one example of a system for sample analysis having a belt transporter and a picker 45. The picker 45 removes the discrete assay cards from the transporter. The picker 45 enables the transporter to be reused repeatedly. Removal of the discrete assay cards from the transporter permits, for example, their collection, and proper storage or disposal, and permits continuous reuse of the transporter.

In some embodiments, the substrate feeder 60 is oriented with respect to the substrate at an angle from 0.1 to 179.9 degrees. In an embodiment, the substrate feeder 60 is normal to the substrate 15.

In some embodiments, the first dispenser 40 is oriented with respect to the substrate 15 at an angle from 60 to 120 degrees. In an embodiment, the first dispenser 40 is normal to the substrate 15. The first dispenser 40 can be normal to the substrate 15 at any point along the second station B. In one embodiment, the first dispenser 40 includes a syringe to dispense the sample 20. In another embodiment, the first dispenser 40 includes a pipette to dispense the sample 20.

In some embodiments, the second dispenser 45 is oriented with respect to the substrate 15 at an angle from 60 to 120 degrees. In an embodiment, the second dispenser 45 is normal to the substrate 15. In other embodiments, the second dispenser 45 can be normal to the substrate 15 at any point along the second station B. In one embodiment, the second dispenser 45 includes a syringe to dispense the reagent. In another embodiment, the second dispenser 45 includes a pipette to dispense the reagent.

In some embodiments, the film feeder 50 is oriented with respect to the substrate 15 at an angle from 0.1 to 179.9 degrees. In an embodiment, the film feeder 50 is normal to the substrate 15.

In some embodiments, the press 55 includes a mechanical press that applies a uniform pressure on the film 25. In one embodiment, the mechanical press includes a rubber material for allowing the mechanical press to apply a more uniform pressure on the film 25. In other embodiments, the press 55 includes an air cushion press that applies a uniform pressure on the film 25. The air cushion press applies a uniform pressure around the entire assay card, thereby significantly increasing pressure uniformity on the film 25. In one embodiment, the press 55 is normal to the substrate 15.

Samples

The devices, apparatus, systems, and methods herein disclosed can be used for samples such as but not limited to diagnostic samples, clinical samples, environmental samples and foodstuff samples. The types of samples include but are not limited to the samples listed, described and/or summarized in PCT Application (designating U.S.) Nos. PCT/US2016/045437 and PCT/US0216/051775, which were respectively filed on Aug. 10, 2016 and Sep. 14, 2016, and are hereby incorporated by reference by their entireties.

For example, in some embodiments, the devices, apparatus, systems, and methods herein disclosed are used for a sample that includes cells, tissues, bodily fluids and/or a mixture thereof. In some embodiments, the sample comprises a human body fluid. In some embodiments, the sample comprises at least one of cells, tissues, bodily fluids, stool, amniotic fluid, aqueous humour, vitreous humour, blood, whole blood, fractionated blood, plasma, serum, breast milk, cerebrospinal fluid, cerumen, chyle, chime, endolymph, perilymph, feces, gastric acid, gastric juice, lymph, mucus, nasal drainage, phlegm, pericardial fluid, peritoneal fluid, pleural fluid, pus, rheum, saliva, sebum, semen, sputum, sweat, synovial fluid, tears, vomit, urine, and exhaled breath condensate.

In some embodiments, the devices, apparatus, systems, and methods herein disclosed are used for an environmental sample that is obtained from any suitable source, such as but not limited to: river, lake, pond, ocean, glaciers, icebergs, rain, snow, sewage, reservoirs, tap water, drinking water, etc.; solid samples from soil, compost, sand, rocks, concrete, wood, brick, sewage, etc.; and gaseous samples from the air, underwater heat vents, industrial exhaust, vehicular exhaust, etc. In certain embodiments, the environmental sample is fresh from the source; in certain embodiments, the environmental sample is processed. For example, samples that are not in liquid form are converted to liquid form before the subject devices, apparatus, systems, and methods are applied.

In some embodiments, the devices, apparatus, systems, and methods herein disclosed are used for a foodstuff sample, which is suitable or has the potential to become suitable for animal consumption, e.g., human consumption. In some embodiments, a foodstuff sample includes raw ingredients, cooked or processed food, plant and animal sources of food, preprocessed food as well as partially or fully processed food, etc. In certain embodiments, samples that are not in liquid form are converted to liquid form before the subject devices, apparatus, systems, and methods are applied.

The subject devices, apparatus, systems, and methods can be used to analyze any volume of the sample. Examples of the volumes include, but are not limited to, about 10 mL or less, 5 mL or less, 3 mL or less, 1 microliter (μL, also “uL” herein) or less, 500 μL or less, 300 μL or less, 250 μL or less, 200 μL or less, 170 μL or less, 150 μL or less, 125 μL or less, 100 μL or less, 75 μL or less, 50 μL or less, 25 μL or less, 20 μL or less, 15 μL or less, 10 μL or less, 5 μL or less, 3 μL or less, 1 μL or less, 0.5 μL or less, 0.1 μL or less, 0.05 μL or less, 0.001 μL or less, 0.0005 μL or less, 0.0001 μL or less, 10 pL or less, 1 pL or less, or a range between any two of the values.

In some embodiments, the volume of the sample includes, but is not limited to, about 100 μL or less, 75 μL or less, 50 μL or less, 25 μL or less, 20 μL or less, 15 μL or less, 10 μL or less, 5 μL or less, 3 μL or less, 1 μL or less, 0.5 μL or less, 0.1 μL or less, 0.05 μL or less, 0.001 μL or less, 0.0005 μL or less, 0.0001 μL or less, 10 pL or less, 1 pL or less, or a range between any two of the values. In some embodiments, the volume of the sample includes, but is not limited to, about 10 μL or less, 5 μL or less, 3 μL or less, 1 μL or less, 0.5 μL or less, 0.1 μL or less, 0.05 μL or less, 0.001 μL or less, 0.0005 μL or less, 0.0001 μL or less, 10 pL or less, 1 pL or less, or a range between any two of the values.

In some embodiments, the amount of the sample is about a drop of liquid. In certain embodiments, the amount of sample is the amount collected from a pricked finger or fingerstick. In certain embodiments, the amount of sample is the amount collected from a microneedle, micropipette or a venous draw.

In certain embodiments, the sample holder is configured to hold a fluidic sample. In certain embodiments, the sample holder is configured to compress at least part of the fluidic sample into a thin layer. In certain embodiments, the sample holder comprises structures that are configured to heat and/or cool the sample. In certain embodiments, the heating source provides electromagnetic waves that can be absorbed by certain structures in the sample holder to change the temperature of the sample. In certain embodiments, the signal sensor is configured to detect and/or measure a signal from the sample. In certain embodiments, the signal sensor is configured to detect and/or measure an analyte in the sample. In certain embodiments, the heat sink is configured to absorb heat from the sample holder and/or the heating source. In certain embodiments, the heat sink comprises a chamber that at least partly enclose the sample holder.

Applications

The devices, apparatus, systems, and methods herein disclosed can be used in various types of biological/chemical sampling, sensing, assays and applications, which include the applications listed, described and/or summarized in PCT Application (designating U.S.) No. PCT/US2016/045437, which was filed on Aug. 10, 2016, and is incorporated by reference by its entirety.

In some embodiments, the devices, apparatus, systems, and methods herein disclosed are used in a variety of different application in various field, wherein determination of the presence or absence, quantification, and/or amplification of one or more analytes in a sample are desired. For example, in certain embodiments the subject devices, apparatus, systems, and methods are used in the detection of proteins, peptides, nucleic acids, synthetic compounds, inorganic compounds, organic compounds, bacteria, virus, cells, tissues, nanoparticles, and other molecules, compounds, mixtures and substances thereof. The various fields in which the subject devices, apparatus, systems, and methods can be used include, but are not limited to: diagnostics, management, and/or prevention of human diseases and conditions, diagnostics, management, and/or prevention of veterinary diseases and conditions, diagnostics, management, and/or prevention of plant diseases and conditions, agricultural uses, veterinary uses, food testing, environments testing and decontamination, drug testing and prevention, and others.

The applications of the present invention include, but are not limited to: (a) the detection, purification, quantification, and/or amplification of chemical compounds or biomolecules that correlates with certain diseases, or certain stages of the diseases, e.g., infectious and parasitic disease, injuries, cardiovascular disease, cancer, mental disorders, neuropsychiatric disorders and organic diseases, e.g., pulmonary diseases, renal diseases, (b) the detection, purification, quantification, and/or amplification of cells and/or microorganism, e.g., virus, fungus and bacteria from the environment, e.g., water, soil, or biological samples, e.g., tissues, bodily fluids, (c) the detection, quantification of chemical compounds or biological samples that pose hazard to food safety, human health, or national security, e.g. toxic waste, anthrax, (d) the detection and quantification of vital parameters in medical or physiological monitor, e.g., glucose, blood oxygen level, total blood count, (e) the detection and quantification of specific DNA or RNA from biological samples, e.g., cells, viruses, bodily fluids, (f) the sequencing and comparing of genetic sequences in DNA in the chromosomes and mitochondria for genome analysis or (g) the detection and quantification of reaction products, e.g., during synthesis or purification of pharmaceuticals.

In some embodiments, the subject devices, apparatus, systems, and methods are used in the detection of nucleic acids, proteins, or other molecules or compounds in a sample. In certain embodiments, the devices, apparatus, systems, and methods are used in the rapid, clinical detection and/or quantification of one or more, two or more, or three or more disease biomarkers in a biological sample, e.g., as being employed in the diagnosis, prevention, and/or management of a disease condition in a subject. In certain embodiments, the devices, apparatus, systems, and methods are used in the detection and/or quantification of one or more, two or more, or three or more environmental markers in an environmental sample, e.g., sample obtained from a river, ocean, lake, rain, snow, sewage, sewage processing runoff, agricultural runoff, industrial runoff, tap water or drinking water. In certain embodiments, the devices, apparatus, systems, and methods are used in the detection and/or quantification of one or more, two or more, or three or more foodstuff marks from a food sample obtained from tap water, drinking water, prepared food, processed food or raw food.

In some embodiments, the subject device is part of a microfluidic device. In some embodiments, the subject devices, apparatus, systems, and methods are used to detect a fluorescence or luminescence signal. In some embodiments, the subject devices, apparatus, systems, and methods include, or are used together with, a communication device, such as but not limited to: mobile phones, tablet computers and laptop computers. In some embodiments, the subject devices, apparatus, systems, and methods include, or are used together with, an identifier, such as but not limited to an optical barcode, a radio frequency ID tag, or combinations thereof.

In some embodiments, the sample is a diagnostic sample obtained from a subject, the analyte is a biomarker, and the measured amount of the analyte in the sample is diagnostic of a disease or a condition. In some embodiments, the subject devices, systems and methods further include receiving or providing to the subject a report that indicates the measured amount of the biomarker and a range of measured values for the biomarker in an individual free of or at low risk of having the disease or condition, wherein the measured amount of the biomarker relative to the range of measured values is diagnostic of a disease or condition.

In some embodiments, the sample is an environmental sample, and wherein the analyte is an environmental marker. In some embodiments, the subject devices, systems and methods include receiving or providing a report that indicates the safety or harmfulness for a subject to be exposed to the environment from which the sample was obtained. In some embodiments, the subject devices, systems and methods include sending data containing the measured amount of the environmental marker to a remote location and receiving a report that indicates the safety or harmfulness for a subject to be exposed to the environment from which the sample was obtained.

In some embodiments, the sample is a foodstuff sample, wherein the analyte is a foodstuff marker, and wherein the amount of the foodstuff marker in the sample correlates with safety of the foodstuff for consumption. In some embodiments, the subject devices, systems and methods include receiving or providing a report that indicates the safety or harmfulness for a subject to consume the foodstuff from which the sample is obtained. In some embodiments, the subject devices, systems and methods include sending data containing the measured amount of the foodstuff marker to a remote location and receiving a report that indicates the safety or harmfulness for a subject to consume the foodstuff from which the sample is obtained.

Analytes, Biomarkers, and Diseases

The devices, apparatus, systems, and methods herein disclosed can be used for the detection, purification and/or quantification of various analytes. In some embodiments, the analytes are biomarkers associated with various diseases. In some embodiments, the analytes and/or biomarkers are indicative of the presence, severity, and/or stage of the diseases. The analytes, biomarkers, and/or diseases that can be detected and/or measured with the devices, apparatus, systems, and/or method of the present invention include the analytes, biomarkers, and/or diseases listed, described and/or summarized in PCT Application (designating U.S.) Nos. PCT/US2016/045437 filed on Aug. 10, 2016, and PCT Application No. PCT/US2016/054025 filed on Sep. 27, 2016, and U.S. Provisional Application Nos. 62/234,538 filed on Sep. 29, 2015, 62/233,885 filed on Sep. 28, 2015, 62/293,188 filed on Feb. 9, 2016, and 62/305,123 filed on Mar. 8, 2016, which are all hereby incorporated by reference by their entireties.

In some embodiments, the analyte can be a biomarker, an environmental marker, or a foodstuff marker. The sample in some instances is a liquid sample, and can be a diagnostic sample (such as saliva, serum, blood, sputum, urine, sweat, lacrima, semen, or mucus); an environmental sample obtained from a river, ocean, lake, rain, snow, sewage, sewage processing runoff, agricultural runoff, industrial runoff, tap water or drinking water; or a foodstuff sample obtained from tap water, drinking water, prepared food, processed food or raw food.

In any embodiment, the sample can be a diagnostic sample obtained from a subject, the analyte can be a biomarker, and the measured amount of the analyte in the sample can be diagnostic of a disease or a condition.

In any embodiment, the devices, apparatus, systems, and methods in the present invention can further include diagnosing the subject based on information including the measured amount of the biomarker in the sample. In some cases, the diagnosing step includes sending data containing the measured amount of the biomarker to a remote location and receiving a diagnosis based on information including the measurement from the remote location.

In any embodiment, the biomarker can be selected from Tables B1, 2, 3 or 7 as disclosed in U.S. Provisional Application Nos. 62/234,538, 62/293,188, and/or 62/305,123, and/or PCT Application No. PCT/US2016/054,025, which are all incorporated in their entireties for all purposes. In some instances, the biomarker is a protein selected from Tables B1, 2, or 3. In some instances, the biomarker is a nucleic acid selected from Tables B2, 3 or 7. In some instances, the biomarker is an infectious agent-derived biomarker selected from Table B2. In some instances, the biomarker is a microRNA (miRNA) selected from Table B7.

In any embodiment, the applying step b) can include isolating miRNA from the sample to generate an isolated miRNA sample, and applying the isolated miRNA sample to the disk-coupled dots-on-pillar antenna (QMAX device) array.

In any embodiment, the QMAX device can contain a plurality of capture agents that each bind to a biomarker selected from Tables B1, B2, B3 and/or B7, wherein the reading step d) includes obtaining a measure of the amount of the plurality of biomarkers in the sample, and wherein the amount of the plurality of biomarkers in the sample is diagnostic of a disease or condition.

In any embodiment, the capture agent can be an antibody epitope and the biomarker can be an antibody that binds to the antibody epitope. In some embodiments, the antibody epitope includes a biomolecule, or a fragment thereof, selected from Tables B4, B5 or B6. In some embodiments, the antibody epitope includes an allergen, or a fragment thereof, selected from Table B5. In some embodiments, the antibody epitope includes an infectious agent-derived biomolecule, or a fragment thereof, selected from Table B6.

In any embodiment, the QMAX device can contain a plurality of antibody epitopes selected from Tables B4, B5 and/or B6, wherein the reading step d) includes obtaining a measure of the amount of a plurality of epitope-binding antibodies in the sample, and wherein the amount of the plurality of epitope-binding antibodies in the sample is diagnostic of a disease or condition.

In any embodiment, the sample can be an environmental sample, and wherein the analyte can be an environmental marker. In some embodiments, the environmental marker is selected from Table B8 in U.S. Provisional Application No. 62/234,538 and/or PCT Application No. PCT/US2016/054025.

In any embodiment, the method can include receiving or providing a report that indicates the safety or harmfulness for a subject to be exposed to the environment from which the sample was obtained.

In any embodiment, the method can include sending data containing the measured amount of the environmental marker to a remote location and receiving a report that indicates the safety or harmfulness for a subject to be exposed to the environment from which the sample was obtained.

In any embodiment, the QMAX device array can include a plurality of capture agents that each binds to an environmental marker selected from Table B8, and wherein the reading step d) can include obtaining a measure of the amount of the plurality of environmental markers in the sample.

In any embodiment, the sample can be a foodstuff sample, wherein the analyte can be a foodstuff marker, and wherein the amount of the foodstuff marker in the sample can correlate with safety of the foodstuff for consumption. In some embodiments, the foodstuff marker is selected from Table B9.

In any embodiment, the method can include receiving or providing a report that indicates the safety or harmfulness for a subject to consume the foodstuff from which the sample is obtained.

In any embodiment, the method can include sending data containing the measured amount of the foodstuff marker to a remote location and receiving a report that indicates the safety or harmfulness for a subject to consume the foodstuff from which the sample is obtained.

In any embodiment, the devices, apparatus, systems, and methods herein disclosed can include a plurality of capture agents that each binds to a foodstuff marker selected from Table B9 from in U.S. Provisional Application No. 62/234,538 and PCT Application No. PCT/US2016/054025, wherein the obtaining can include obtaining a measure of the amount of the plurality of foodstuff markers in the sample, and wherein the amount of the plurality of foodstuff marker in the sample can correlate with safety of the foodstuff for consumption.

Also provided herein are kits that find use in practicing the devices, systems and methods in the present invention.

The amount of sample can be about a drop of a sample. The amount of sample can be the amount collected from a pricked finger or fingerstick. The amount of sample can be the amount collected from a microneedle or a venous draw.

A sample can be used without further processing after obtaining it from the source, or can be processed, e.g., to enrich for an analyte of interest, remove large particulate matter, dissolve or resuspend a solid sample, etc.

Any suitable method of applying a sample to the QMAX device can be employed. Suitable methods can include using a pipette, dropper, syringe, etc. In certain embodiments, when the QMAX device is located on a support in a dipstick format, as described below, the sample can be applied to the QMAX device by dipping a sample-receiving area of the dipstick into the sample.

A sample can be collected at one time, or at a plurality of times. Samples collected over time can be aggregated and/or processed (by applying to a QMAX device and obtaining a measurement of the amount of analyte in the sample, as described herein) individually. In some instances, measurements obtained over time can be aggregated and can be useful for longitudinal analysis over time to facilitate screening, diagnosis, treatment, and/or disease prevention.

Washing the QMAX device to remove unbound sample components can be done in any convenient manner, as described above. In certain embodiments, the surface of the QMAX device is washed using binding buffer to remove unbound sample components. Detectable labeling of the analyte can be done by any convenient method. The analyte can be labeled directly or indirectly. In direct labeling, the analyte in the sample is labeled before the sample is applied to the QMAX device. In indirect labeling, an unlabeled analyte in a sample is labeled after the sample is applied to the QMAX device to capture the unlabeled analyte, as described below.

Labels

The devices, apparatus, systems, and methods herein disclosed can be used with various types of labels, which include the labels disclosed, described and/or summarized in PCT Application (designating U.S.) No. PCT/US2016/045437, which was filed on Aug. 10, 2016, and is hereby incorporated by reference by its entirety.

In some embodiments, the label is optically detectable, such as but not limited to a fluorescence label. In some embodiments, the labels include, but are not limited to, IRDye800CW, Alexa 790, Dylight 800, fluorescein, fluorescein isothiocyanate, succinimidyl esters of carboxyfluorescein, succinimidyl esters of fluorescein, 5-isomer of fluorescein dichlorotriazine, caged carboxyfluorescein-alanine-carboxamide, Oregon Green 488, Oregon Green 514; Lucifer Yellow, acridine Orange, rhodamine, tetramethylrhodamine, Texas Red, propidium iodide, JC-1 (5,5′,6,6′-tetrachloro-1,1′,3,3′-tetraethylbenzimidazoylcarbocyanine iodide), tetrabromorhodamine 123, rhodamine 6G, TMRM (tetramethyl rhodamine methyl ester), TMRE (tetramethyl rhodamine ethyl ester), tetramethylrosamine, rhodamine B and 4-dimethylaminotetramethylrosamine, green fluorescent protein, blue-shifted green fluorescent protein, cyan-shifted green fluorescent protein, red-shifted green fluorescent protein, yellow-shifted green fluorescent protein, 4-acetamido-4′-isothiocyanatostilbene-2,2′ di sulfonic acid; acridine and derivatives, such as acridine, acridine isothiocyanate; 5-(2′-aminoethyl)aminonaphthalene-1-sulfonic acid (EDANS); 4-amino-N-[3-vinyl sulfonyl)phenyl]naphth-alimide-3,5 disulfonate; N-(4-anilino-1-naphthyl)maleimide; anthranilamide; 4,4-difluoro-5-(2-thienyl)-4-bora-3a,4a diaza-5-indacene-3-propioni-c acid BODIPY; cascade blue; Brilliant Yellow; coumarin and derivatives: coumarin, 7-amino-4-methylc oumarin (AMC, Coumarin 120),7-amino-4-trifluoromethylcoumarin (Coumarin 151); cyanine dyes; cyanosine; 4′,6-diaminidino-2-phenylindole (DAPI); 5′,5″-dibromopyrogallol-sulfonaphthalein (Bromopyrogallol Red); 7-diethylamino-3-(4′-isothiocyanatophenyl)-4-methyl c oum arin; di ethyl enetri aamine pentaacetate; 4,4′-diisothiocyanatodihydro-stilbene-2-,2′-di sulfonic acid; 4,4′-diisothiocyanatostilbene-2,2′-disulfonic acid; 5-(dimethylaminolnaphthalene-1-sulfonyl chloride (DNS, dansylchloride); 4-dimethylaminophenylazophenyl-4′-isothiocyanate (DABITC); eosin and derivatives: eosin, eosin isothiocyanate, erythrosin and derivatives: erythrosin B, erythrosin, isothiocyanate; ethidium; fluorescein and derivatives: 5-carboxyfluorescein (FAM),5-(4,6-dichlorotriazin-2-yl)amino-fluorescein (DTAF), 2′,7′ dimethoxy-4′ 5′-dichloro-6-carboxyfluorescein (JOE), fluorescein, fluorescein isothiocyanate, QFITC, (XRITC); fluorescamine; IR144; IR1446; Malachite Green isothiocyanate; 4-methylumbelli-feroneortho cresolphthalein; nitrotyrosine; pararosaniline; Phenol Red; B-phycoerythrin; o-phthaldialdehyde; pyrene and derivatives: pyrene, pyrene butyrate, succinimidyl 1-pyrene; butyrate quantum dots; Reactive Red 4 (Cibacron™ Brilliant Red 3B-A) rhodamine and derivatives: 6-carboxy-X-rhodamine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of sulforhodamine 101 (Texas Red); N,N,N′,N′-tetramethyl-6-carboxyrhodamine (TAMRA); tetramethyl rhodamine; tetramethyl hodamine isothiocyanate (TRITC); riboflavin; 5-(2′-aminoethyl) aminonaphthalene-1-sulfonic acid (EDANS), 4-(4′-dimethylaminophenylazo)benzoic acid (DABCYL), rosolic acid; CAL Fluor Orange 560; terbium chelate derivatives; Cy 3; Cy 5; Cy 5.5; Cy 7; IRD 700; IRD 800; La Jolla Blue; phthalo cyanine; and naphthalo cyanine, coumarins and related dyes, xanthene dyes such as rhodols, resorufins, bimanes, acridines, isoindoles, dansyl dyes, aminophthalic hydrazides such as luminol, and isoluminol derivatives, aminophthalimides, aminonaphthalimides, aminobenzofurans, aminoquinolines, dicyanohydroquinones, fluorescent europium and terbium complexes; combinations thereof, and the like. Suitable fluorescent proteins and chromogenic proteins include, but are not limited to, a green fluorescent protein (GFP), including, but not limited to, a GFP derived from Aequoria victoria or a derivative thereof, e.g., a “humanized” derivative such as Enhanced GFP; a GFP from another species such as Renilla reniformis, Renilla mulleri, or Ptilosarcus guernyi; “humanized” recombinant GFP (hrGFP); any of a variety of fluorescent and colored proteins from Anthozoan species; combinations thereof; and the like.

QMAX Device

The devices, apparatus, systems, and methods herein disclosed can include or use a QMAX device ((Q: quantification; M: magnifying; A: adding reagents; X: acceleration; also known as Q-card in some embodiments or compressed regulated open flow (CROF) device), which include the QMAX device listed, described and/or summarized in PCT Application (designating U.S.) Nos. PCT/US2016/045437 filed on Aug. 10, 2016, and U.S Provisional Application Nos. 62,431,639 filed on Dec. 9, 2016 and 62/456,287 filed on Feb. 8, 2017, which are all hereby incorporated by reference by their entireties.

As used here, the terms “CROF Card (or card)”, “COF Card”, “QMAX-Card”, “Q-Card”, “CROF device”, “COF device”, “QMAX-device”, “CROF plates”, “COF plates”, and “QMAX-plates” are interchangeable, except that in some embodiments, the COF card does not comprise spacers; and the terms refer to a device that comprises a first plate and a second plate that are movable relative to each other into different configurations (including an open configuration and a closed configuration), and that comprises spacers (except some embodiments of the COF) that regulate the spacing between the plates. The term “X-plate” refers to one of the two plates in a CROF card, wherein the spacers are fixed to this plate. More descriptions of the COF Card, CROF Card, and X-plate are described in the provisional application serial nos. 62/456,065, filed on Feb. 7, 2017, which is incorporated herein in its entirety for all purposes.

The term “compressed open flow (COF)” refers to a method that changes the shape of a flowable sample deposited on a plate by (i) placing other plate on top of at least a part of the sample and (ii) then compressing the sample between the two plates by pushing the two plates towards each other; wherein the compression reduces a thickness of at least a part of the sample and makes the sample flow into open spaces between the plates. The term “compressed regulated open flow” or “CROF” (or “self-calibrated compressed open flow” or “SCOF” or “SCCOF”) (also known as QMAX) refers to a particular type of COF, wherein the final thickness of a part or entire sample after the compression is “regulated” by spacers, wherein the spacers are placed between the two plates. Here the CROF device is used interchangeably with the QMAX card.

The term “open configuration” of the two plates in a QMAX process means a configuration in which the two plates are either partially or completely separated apart and the spacing between the plates is not regulated by the spacers

The term “closed configuration” of the two plates in a QMAX process means a configuration in which the plates are facing each other, the spacers and a relevant volume of the sample are between the plates, the relevant spacing between the plates, and thus the thickness of the relevant volume of the sample, is regulated by the plates and the spacers, wherein the relevant volume is at least a portion of an entire volume of the sample.

The term “a sample thickness is regulated by the plate and the spacers” in a QMAX process means that for a give condition of the plates, the sample, the spacer, and the plate compressing method, the thickness of at least a port of the sample at the closed configuration of the plates can be predetermined from the properties of the spacers and the plate.

The term “inner surface” or “sample surface” of a plate in a QMAX card refers to the surface of the plate that touches the sample, while the other surface (that does not touch the sample) of the plate is termed “outer surface”.

The term “height” or “thickness” of an object in a QMAX process refers to, unless specifically stated, the dimension of the object that is in the direction normal to a surface of the plate. For example, spacer height is the dimension of the spacer in the direction normal to a surface of the plate, and the spacer height and the spacer thickness means the same thing.

The term “area” of an object in a QMAX process refers to, unless specifically stated, the area of the object that is parallel to a surface of the plate. For example, spacer area is the area of the spacer that is parallel to a surface of the plate.

The term QMAX card refers the device that perform a QMAX (e.g., CROF) process on a sample, and have or not have a hinge that connect the two plates.

The term “QMAX card with a hinge and “QMAX card” are interchangeable.

The term “angle self-maintain”, “angle self-maintaining”, or “rotation angle self-maintaining” refers to the property of the hinge, which substantially maintains an angle between the two plates, after an external force that moves the plates from an initial angle into the angle is removed from the plates.

In using QMAX card, the two plates need to be open first for sample deposition. However, in some embodiments, the QMAX card from a package has the two plates are in contact with each other (e.g., a close position), and to separate them is challenges, since one or both plates are very thing. To facilitate an opening of the QMAX card, opening notch or notches are created at the edges or corners of the first plate or both places, and, at the close position of the plates, a part of the second plate placed over the opening notch, hence in the notch of the first plate, the second plate can be lifted open without a blocking of the first plate.

In the QMAX assay platform, a QMAX card uses two plates to manipulate the shape of a sample into a thin layer (e.g., by compressing). In certain embodiments, the plate manipulation needs to change the relative position (termed: plate configuration) of the two plates several times by human hands or other external forces. There is a need to design the QMAX card to make the hand operation easy and fast.

In QMAX assays, one of the plate configurations is an open configuration, wherein the two plates are completely or partially separated (the spacing between the plates is not controlled by spacers) and a sample can be deposited. Another configuration is a closed configuration, wherein at least part of the sample deposited in the open configuration is compressed by the two plates into a layer of highly uniform thickness, the uniform thickness of the layer is confined by the inner surfaces of the plates and is regulated by the plates and the spacers. In some embodiments, the average spacing between the two plates is more than 300 μm.

In a QMAX assay operation, an operator needs to first make the two plates to be in an open configuration ready for sample deposition, then deposit a sample on one or both of the plates, and finally close the plates into a close position. In certain embodiments, the two plates of a QMAX card are initially on top of each other and need to be separated to get into an open configuration for sample deposition. When one of the plate is a thin plastic film (175 μm thick PMA), such separation can be difficult to perform by hand. The present invention intends to provide the devices and methods that make the operation of certain assays, such as the QMAX card assay, easy and fast.

In some embodiments, the QMAX device comprises a hinge that connect two or more plates together, so that the plates can open and close in a similar fashion as a book. In some embodiments, the material of the hinge is such that the hinge can self-maintain the angle between the plates after adjustment. In some embodiments, the hinge is configured to maintain the QMAX card in the closed configuration, such that the entire QMAX card can be slide in and slide out a card slot without causing accidental separation of the two plates. In some embodiments, the QMAX device comprises one or more hinges that can control the rotation of more than two plates.

In some embodiments, the hinge is made from a metallic material that is selected from a group consisting of gold, silver, copper, aluminum, iron, tin, platinum, nickel, cobalt, alloys, or any combination of thereof. In some embodiments, the hinge comprises a single layer, which is made from a polymer material, such as but not limited to plastics. The polymer material is selected from the group consisting of acrylate polymers, vinyl polymers, olefin polymers, cellulosic polymers, noncellulosic polymers, polyester polymers, Nylon, cyclic olefin copolymer (COC), poly(methyl methacrylate) (PMMB), polycarbonate (PC), cyclic olefin polymer (COP), liquid crystalline polymer (LCP), polyimide (PB), polyethylene (PE), polyimide (PI), polypropylene (PP), poly(phenylene ether) (PPE), polystyrene (PS), polyoxymethylene (POM), polyether ether ketone (PEEK), polyether sulfone (PES), poly(ethylene phthalate) (PET), polytetrafluoroethylene (PTFE), polyvinyl chloride (PVC), polyvinylidene fluoride (PVDF), polybutylene terephthalate (PBT), fluorinated ethylene propylene (FEP), perfluoroalkoxyalkane (PFB), polydimethylsiloxane (PDMS), rubbers, or any combinations of thereof. In some embodiments, the polymer material is selected from polystyrene, PMMB, PC, COC, COP, other plastic, or any combination of thereof.

In some embodiments, the QMAX device comprises opening mechanisms such as but not limited to notches on plate edges or strips attached to the plates, making is easier for a user to manipulate the positioning of the plates, such as but not limited to separating the plates of by hand.

In some embodiments, the QMAX device comprises trenches on one or both of the plates. In certain embodiments, the trenches limit the flow of the sample on the plate.

Spacers

The devices, apparatus, systems, and methods herein disclosed can include or use a device (e.g., a QMAX device), which comprises spacers that are listed, described and/or summarized in PCT Application (designating U.S.) No. PCT/US2016/045437 filed on Aug. 10, 2016, and U.S Provisional Application Nos. 62,431,639 filed on Dec. 9, 2016 and 62/456,287 filed on Feb. 8, 2017, which are all hereby incorporated by reference by their entireties.

In essence, the term “spacers” or “stoppers” refers to, unless stated otherwise, the mechanical objects that set, when being placed between two plates, a limit on the minimum spacing between the two plates that can be reached when compressing the two plates together. Namely, in the compressing, the spacers will stop the relative movement of the two plates to prevent the plate spacing becoming less than a preset (i.e., predetermined) value.

The term “a spacer has a predetermined height” and “spacers have a predetermined inter-spacer distance” means, respectively, that the value of the spacer height and the inter spacer distance is known prior to a QMAX process. It is not predetermined, if the value of the spacer height and the inter-spacer distance is not known prior to a QMAX process. For example, in the case that beads are sprayed on a plate as spacers, where beads are landed at random locations of the plate, the inter-spacer distance is not predetermined. Another example of not predetermined inter spacer distance is that the spacers move during a QMAX processes.

The term “a spacer is fixed on its respective plate” in a QMAX process means that the spacer is attached to a location of a plate and the attachment to that location is maintained during a QMAX (i.e., the location of the spacer on respective plate does not change) process. An example of “a spacer is fixed with its respective plate” is that a spacer is monolithically made of one piece of material of the plate, and the location of the spacer relative to the plate surface does not change during the QMAX process. An example of “a spacer is not fixed with its respective plate” is that a spacer is glued to a plate by an adhesive, but during a use of the plate, during the QMAX process, the adhesive cannot hold the spacer at its original location on the plate surface and the spacer moves away from its original location on the plate surface.

Adaptor

The devices, apparatus, systems, and methods herein disclosed can be used with an adaptor, which is configured to accommodate the device and connect the device to a reader, such as but not limited to a smartphone. In some embodiments, the Q-cards are used together with sliders that allow the card to be inserted into the adaptor so that the card can be read by a smartphone detection system. The structure, material, function, variation, dimension and connection of the Q-card, the sliders, and the adaptor are disclosed, listed, described, and/or summarized in PCT Application (designating U.S.) Nos. PCT/US2016/045437 filed on Aug. 10, 2016 and PCT/US0216/051775 filed on Sep. 14, 2016, US Provisional Application Nos. 62/456,590 filed on Feb. 8, 2017, 62/459,554 filed on Feb. 15, 2017, and 62/460,075 filed on Feb. 8, 2017, all of which applications are incorporated herein in their entireties for all purposes.

In some embodiments, the adaptor comprises a receptacle slot, which is configured to accommodate the QMAX device when the device is in a closed configuration. In certain embodiments, the QMAX device has a sample deposited therein and the adaptor can be connected to a mobile device (e.g., a smartphone) so that the sample can be read by the mobile device. In certain embodiments, the mobile device can detect and/or analyze a signal from the sample. In certain embodiments, the mobile device can capture images of the sample when the sample is in the QMAX device and positioned in the field of view (FOV) of a camera, which in certain embodiments, is part of the mobile device.

In some embodiments, the adaptor comprises optical components, which are configured to enhance, magnify, and/or optimize the production of the signal from the sample. In some embodiments, the optical components include parts that are configured to enhance, magnify, and/or optimize illumination provided to the sample. In certain embodiments, the illumination is provided by a light source that is part of the mobile device. In some embodiments, the optical components include parts that are configured to enhance, magnify, and/or optimize a signal from the sample. The structures, functions, and configurations of the optical components in some embodiments can be found in PCT Application (designating U.S.) Nos. PCT/US2016/045437 filed on Aug. 10, 2016 and PCT/US0216/051775 filed on Sep. 14, 2016, US Provisional Application Nos. 62/456,590 filed on Feb. 8, 2017, 62/459,554 filed on Feb. 15, 2017, and 62/460,075 filed on Feb. 8, 2017, all of which applications are incorporated herein in their entireties for all purposes.

Dimensions

The devices, apparatus, systems, and methods herein disclosed can include or use a QMAX device, which can comprise plates and spacers. In some embodiments, the dimension of the individual components of the QMAX device and its adaptor are listed, described and/or summarized in PCT Application (designating U.S.) No. PCT/US2016/045437 filed on Aug. 10, 2016, and U.S Provisional Application Nos. 62,431,639 filed on Dec. 9, 2016 and 62/456,287 filed on Feb. 8, 2017, which are all hereby incorporated by reference by their entireties.

In some embodiments, the dimensions are listed in the Tables below:

### Plates:

| Para- | | Preferred |
|---|---|---|
| meters | Embodiments | Embodiments |
| Shape | round, ellipse, rectangle, triangle, | at least one of the two |
| | polygonal, ring-shaped, or any | (or more) plates of the |
| | superposition of these shapes; the | QMAX card has round |
| | two (or more) plates of the QMAX | corners for user safety |
| | card can have the same size and/or | concerns, wherein the |
| | shape, or different size and/or | round corners have a |
| | shape; | diameter of 100 μm |
| | | or less, 200 μm or less, |
| | | 500 μm or less, 1 mm |
| | | or less, 2 mm or less, |
| | | 5 mm or less, 10 mm |
| | | or less, 50 mm or less, |
| | | or in a range between |
| | | any two of the values. |
| Thickness | the average thickness for at least | For at least one of the |
| | one of the plates is 2 nm or less, | plates is in the range of |
| | 10 nm or less, 100 nm or less, 200 | 0.5 to 1.5 mm; around |
| | nm or less, 500 nm or less, 1000 | 1 mm; in the range of |
| | nm or less, 2 μm (micron) or less, | 0.15 to 0.2 mm; or |
| | 5 μm or less, 10 μm or less, 20 μm | around 0.175 mm |
| | or less, 50 μm or less, 100 μm or | |
| | less, 150 μm or less, 200 μm or | |
| | less, 300 μm or less, 500 μm or | |
| | less, 800 μm or less, 1 mm | |
| | (millimeter) or less, 2 mm or less, | |
| | 3 mm or less, 5 mm or less, 10 | |
| | mm or less, 20 mm or less, 50 mm | |
| | or less, 100 mm or less, 500 mm or | |
| | less, or in a range between any two | |
| | of these values | |
| Lateral | For at least one of the plate is 1 | For at least one plate |
| Area | mm2 (square millimeter) or less, | of the QMAX card is |
| | 10 mm2 or less, 25 mm2 or less, | in the range of 500 to |
| | 50 mm2 or less, 75 mm2 or less, | 1000 mm²; or around |
| | 1 cm2 (square centimeter) or less, | 750 mm². |
| | 2 cm2 or less, 3 cm2 or less, 4 cm2 | |
| | or less, 5 cm2 or less, 10 cm2 or | |
| | less, 100 cm2 or less, 500 cm2 or | |
| | less, 1000 cm2 or less, 5000 cm2 or | |
| | less, 10,000 cm2 or less, 10,000 | |
| | cm2 or less, or in a range between | |
| | any two of these values | |
| Lateral | For at least one of the plates of the | For at least one plate |
| Linear | QMAX card is 1 mm or less, 5 mm | of the QMAX card is |
| Dimension | or less, 10 mm or less, 15 mm or | in the range of 20 to |
| (width, | less, 20 mm or less, 25 mm or | 30 mm; or around |
| length, or | less, 30 mm or less, 35 mm or | 24 mm |
| diameter, | less, 40 mm or less, 45 mm or | |
| etc.) | less, 50 mm or less, 100 mm or | |
| | less, 200 mm or less, 500 mm or | |
| | less, 1000 mm or less, 5000 mm or | |
| | less, or in a range between any two | |
| | of these values | |
| Recess | 1 μm or less, 10 μm or less, 20 μm | In the range of 1 mm |
| width | or less, 30 μm or less, 40 μm or | to 10 mm; Or About |
| | less, 50 μm or less, 100 μm or less, | 5 mm |
| | 200 μm or less, 300 μm or less, | |
| | 400 μm or less, 500 μm or less, | |
| | 7500 μm or less, 1 mm or less, | |
| | 5 mm or less, 10 mm or less, 100 | |
| | mm or less, or 1000 mm or less, or | |
| | in a range between any two of these | |
| | values. | |

### Hinge:

| | | Preferred |
|---|---|---|
| Parameters | Embodiments | Embodiments |
| Number | 1, 2, 3, 4, 5, or more | 1 or 2 |
| Length of | 1 mm or less, 2 mm or less, 3 mm or | In the range |
| Hinge Joint | less, 4 mm or less, 5 mm or less, 10 mm | of 5 mm to |
| | or less, 15 mm or less, 20 mm or less, 25 | 30 mm. |
| | mm or less, 30 mm or less, 40 mm or | |
| | less, 50 mm or less, 100 mm or less, 200 | |
| | mm or less, or 500 mm or less, or in a | |
| | range between any two of these values | |
| Ratio (hinge | 1.5 or less, 1 or less, 0.9 or less, 0.8 or | In the range |
| joint length | less, 0.7 or less, 0.6 or less, 0.5 or less, | of 0.2 to 1; |
| vs. aligning | 0.4 or less, 0.3 or less, 0.2 or less, 0.1 or | or about 1 |
| plate edge | less, 0.05 or less or in a range between | |
| length | any two of these values. | |
| Area | 1 mm² or less, 5 mm² or less, 10 mm² or | In the range |
| | less, 20 mm² or less, 30 mm² or less, 40 | of 20 to 200 |
| | mm² or less, 50 mm² or less, 100 mm² or | mm²; or |
| | less, 200 mm² or less, 500 mm² or less, or | about |
| | in a range between any of the two values | 120 mm² |
| Ratio (hinge | 1 or less, 0.9 or less, 0.8 or less, 0.7 or | In the range |
| area vs. | less, 0.6 or less, 0.5 or less, 0.4 or less, | of 0.05 to |
| plate area) | 0.3 or less, 0.2 or less, 0.1 or less, 0.05 | 0.2, around |
| | or less, 0.01 or less or in a range between | 0.15 |
| | any two of these values | |
| Max. Open | 15 or less, 30 or less, 45 or less, 60 or | In the range |
| Degree | less, 75 or less, 90 or less, 105 or less, | of 90 to 180 |
| | 120 or less, 135 or less, 150 or less, 165 | degrees |
| | or less, 180 or less, 195 or less, 210 or | |
| | less, 225 or less, 240 or less, 255 or less, | |
| | 270 or less, 285 or less, 300 or less, 315 | |
| | or less, 330 or less, 345 or less or 360 or | |
| | less degrees, or in a range between any | |
| | two of these values | |
| No. of | 1, 2, 3, 4, 5, or more | 1 or 2 |
| Layers | | |
| Layer | 0.1 μm or less, 1 μm or less, 2 μm or | In the range |
| thickness | less, 3 μm or less, 5 μm or less, 10 μm | of 20 μm to |
| | or less, 20 μm or less, 30 μm or less, 50 | 1 mm; or |
| | μm or less, 100 μm or less, 200 μm or | around 50 |
| | less, 300 μm or less, 500 μm or less, 1 | μm |
| | mm or less, 2 mm or less, and a range | |
| | between any two of these values | |
| Angle- | Limiting the angle adjustment with no | No more |
| maintaining | more than ±90, ±45, ±30, ±25, ±20, ±15, | than ±2 |
| | ±10, ±8, ±6, ±5, ±4, ±3, ±2, or ±1, or in | |
| | a range between any two of these values | |

### Notch:

| | | Preferred |
|---|---|---|
| Parameters | Embodiments | Embodiments |
| Number | 1, 2, 3, 4, 5, or more | 1 or 2 |
| Shape | round, ellipse, rectangle, triangle, | Part of a |
| | polygon, ring-shaped, or any | circle |
| | superposition or portion of these shapes. | |
| Positioning | Any location along any edge except the | |
| | hingeedge, or any corner joint by non- | |
| | hinge edges | |
| Lateral | 1 mm or less, 2.5 mm or less, 5 mm or | In the range |
| Linear | less, 10 mm or less, 15 mm or less, 20 | of 5 mm to |
| Dimension | mm or less, 25 mm or less, 30 mm or | 15 mm; or |
| (Length | less, 40 mm 5 or less, 0 mm or less, or | about 10 mm |
| along the | in a range between any two of these | |
| edge, | values | |
| radius, etc.) | | |
| Area | 1 mm² (square millimeter) or less, 10 | In the range |
| | mm² or less, 25 mm² or less, 50 mm² | of 10 to 150 |
| | or less, 75 mm² or less or in a range | mm²; or |
| | between any two of these values. | about 50 |
| | | mm² |

### Trench:

| Para- | | Preferred |
|---|---|---|
| meters | Embodiments | Embodiments |
| Number | 1, 2, 3, 4, 5, or more | 1 or 2 |
| Shape | Closed (round, ellipse, rectangle, triangle, | |
| | polygon, ring-shaped, or any superposition | |
| | or portion of these shapes) or open-ended | |
| | (straight line, curved line, arc, branched | |
| | tree, or any other shape with open endings); | |
| Length | 0.001 mm or less, 0.005 mm or less, 0.01 | |
| | mm or less, 0.05 mm or less, 0.1 mm or | |
| | less, 0.5 mm or less, 1 mm or less, 2 mm | |
| | or less, 5 mm or less, 10 mm or less, 20 | |
| | mm or less, 50 mm or less, 100 mm or less, | |
| | or in a range between any two of these | |
| | values | |
| Cross- | 0.001 mm² or less, 0.005 mm² or less, 0.01 | |
| sectional | mm² or less, 0.05 mm² or less, 0.1 mm² or | |
| Area | less, 0.5 mm² or less, 1 mm² or less, 2 mm² | |
| | or less, 5 mm² or less, 10 mm² or less, 20 | |
| | mm² or less, or in a range between any two | |
| | of these values. | |
| Volume | 0.1 ul or more, 0.5 ul or more, 1 ul or | In the range |
| | more, 2 ul or more, 5 ul or more, 10 ul or | of 1 ul to 20 |
| | more, 30 ul or more, 50 ul or more, 100 ul | ul; or about |
| | or more, 500 ul or more, 1 mL or more, or | 5 ul |
| | in a range between any two of these values | |

### Receptacle Slot

| | | Preferred |
|---|---|---|
| Parameters | Embodiments | Embodiments |
| Shape of | round, ellipse, rectangle, triangle, polygon, | |
| receiving | ring-shaped, or any superposition of these | |
| area | shapes; | |
| Difference | 100 nm, 500 nm, 1 μm, 2 μm, 5 μm, 10 | In the range |
| between | μm, 50 μm, 100 μm, 300 μm, 500 μm, | of 50 to 300 |
| sliding | 1 mm, 2 mm, 5 mm, 1 cm, or in a range | μm; or about |
| track gap | between any two of the values. | 75 μm |
| size and | | |
| card | | |
| thickness | | |
| Difference | 1 mm² (square millimeter) or less, 10 mm² | |
| between | or less, 25 mm² or less, 50 mm² or less, 75 | |
| receiving | mm² or less, 1 cm² (square centimeter) or | |
| area and | less, 2 cm² or less, 3 cm² or less, 4 cm² or | |
| card area | less, 5 cm² or less, 10 cm² or less, 100 cm² | |
| | or less, or in a range between any of the | |
| | two values. | |

Certain Conditions for achieving uniform thickness using QMAX card.

In some embodiments, the inter-spacer distance is in the range of 1 μm to 120 μm.

In some embodiments, wherein the plates have a thickness in the range of 20 μm to 250 μM and Young's modulus in the range 0.1 to 5 GPa.

In some embodiments, for a flexible plate, the thickness of the flexible plate times the Young's modulus of the flexible plate is in the range 60 to 750 GPa-m.

In some embodiments, for a flexible plate, the thickness of the flexible plate times the Young's modulus of the flexible plate is in the range 60 to 600 GPa-μm.

In some embodiments, the layer of uniform thickness sample is uniform over a lateral area that is at least 1 mm².

In some embodiments, the layer of highly uniform thickness sample has a thickness uniformity of up to +/−5%.

In some embodiments, the spacers are pillars with a cross-sectional shape selected from round, polygonal, circular, square, rectangular, oval, elliptical, or any combination of the same.

In some embodiments, the spacers have pillar shape, have a substantially flat top surface, and have substantially uniform cross-section, wherein, for each spacer, the ratio of the lateral dimension of the spacer to its height is at least 1.

In some embodiments, the spacers are configured in a periodic array form.

In some embodiments, the spacers have a filling factor of 1% or higher, wherein the filling factor is the ratio of the spacer contact area to the total plate area.

In some embodiments, the Young's modulus of the spacers times the filling factor of the spacers is equal or larger than 20 MPa, wherein the filling factor is the ratio of the spacer contact area to the total plate area.

In some embodiments, the spacing between the two plates at the closed configuration is less than 200 μm.

In some embodiments, the spacing between the two plates at the closed configuration is a value between 1.8 μm and 3.5 μm.

In some embodiments, the spacers are fixed on a plate by directly embossing the plate or injection molding of the plate.

In some embodiments, the materials of the plate and the spacers are selected from polystyrene, PMMA, PC, COC, COP, or another plastic.

In some embodiments, the spacers have a pillar shape, and the sidewall corners of the spacers have a round shape with a radius of curvature at least 1 μm.

In some embodiments, the pressing is by human hand.

In some embodiments, at least a portion of the inner surface of one plate or both plates are hydrophilic.

In some embodiments, the sample is a deposit directly from a subject to the plate without using any transferring devices.

In some embodiments, after the sample deformation at a closed configuration, the sample maintains the same final sample thickness, when some or all of the compressing forces are removed.

In some embodiments, the spacers have pillar shape and nearly uniform cross-section.

In some embodiments, the inter-spacer distance (SD) is equal or less than about 120 μm (micrometer).

In some embodiments, the inter-spacer distance (SD) is equal or less than about 100 lam (micrometer).

In some embodiments, the fourth power of the inter-spacer-distance (ISD) divided by the thickness (h) and the Young's modulus (E) of the flexible plate (ISD⁴/(hE)) is 5×10⁶ μm³/GPa or less.

In some embodiments, the fourth power of the inter-spacer-distance (ISD) divided by the thickness (h) and the Young's modulus (E) of the flexible plate (ISD⁴/(hE)) is 5×10⁵ μm³/GPa or less.

In some embodiments, the spacers have pillar shape, a substantially flat top surface, a predetermined substantially uniform height, and a predetermined constant inter-spacer distance that is at least about 2 times larger than the size of the analyte, wherein the Young's modulus of the spacers times the filling factor of the spacers is equal or larger than 2 MPa, wherein the filling factor is the ratio of the spacer contact area to the total plate area, and wherein, for each spacer, the ratio of the lateral dimension of the spacer to its height is at least 1 (one).

In some embodiments, the spacers have pillar shape, a substantially flat top surface, a predetermined substantially uniform height, and a predetermined constant inter-spacer distance that is at least about 2 times larger than the size of the analyte, wherein the Young's modulus of the spacers times the filling factor of the spacers is equal or larger than 2 MPa, wherein the filling factor is the ratio of the spacer contact area to the total plate area, and wherein, for each spacer, the ratio of the lateral dimension of the spacer to its height is at least 1 (one), wherein the fourth power of the inter-spacer-distance (ISD) divided by the thickness (h) and the Young's modulus (E) of the flexible plate (ISD⁴/(hE)) is 5×10⁶ m ³/GPa or less.

In some embodiments, the ratio of the inter-spacing distance of the spacers to the average width of the spacer is 2 or larger, and the filling factor of the spacers multiplied by the Young's modulus of the spacers is 2 MPa or larger.

In some embodiments, the analytes are the analyte in a detection of proteins, peptides, nucleic acids, synthetic compounds, and inorganic compounds.

In some embodiments, the spacers have a shape of pillars and a ratio of the width to the height of the pillar is equal or larger than one.

In some embodiments, the sample that is deposited on one or both of the plates has an unknown volume.

In some embodiments, each spacer has a shape of pillar, and the pillar has substantially uniform cross-section.

In some embodiments, the sample is for the detection, purification and quantification of chemical compounds or biomolecules that correlate with the stage of certain diseases.

In some embodiments, the sample is related to infectious and parasitic disease, injuries, cardiovascular disease, cancer, mental disorders, neuropsychiatric disorders, pulmonary diseases, renal diseases, and other and organic diseases.

In some embodiments, the sample is related to the detection, purification and quantification of microorganisms.

In some embodiments, the sample is related to viruses, fungus and bacteria from environment, water, soil, or biological samples.

In some embodiments, the sample is related to the detection, quantification of chemical compounds or biological samples that pose hazard to food safety, national security, toxic waste, or anthrax.

In some embodiments, the sample is related to quantification of vital parameters in medical or physiological monitor.

In some embodiments, the sample is related to glucose, blood, oxygen level, total blood count.

In some embodiments, the sample is related to the detection and quantification of specific DNA or RNA from biosamples.

In some embodiments, the sample is related to the sequencing and comparing of genetic sequences in DNA in the chromosomes and mitochondria for genome analysis.

In some embodiments, the sample is related to detect reaction products, e.g., during synthesis or purification of pharmaceuticals.

In some embodiments, the sample is cells, tissues, bodily fluids, and stool.

In some embodiments, the sample is the sample in the detection of proteins, peptides, nucleic acids, synthetic compounds, inorganic compounds.

In some embodiments, the sample is the sample in the fields of human, veterinary, agriculture, foods, environments, and drug testing.

In some embodiments, the sample is a biological sample selected from the group consisting of blood, serum, plasma, a nasal swab, a nasopharyngeal wash, saliva, urine, gastric fluid, spinal fluid, tears, stool, mucus, sweat, earwax, oil, a glandular secretion, cerebral spinal fluid, tissue, semen, vaginal fluid, interstitial fluids derived from tumorous tissue, ocular fluids, spinal fluid, a throat swab, breath, hair, finger nails, skin, biopsy, placental fluid, amniotic fluid, cord blood, lymphatic fluids, cavity fluids, sputum, pus, microbiota, meconium, breast milk, exhaled condensate nasopharyngeal wash, nasal swab, throat swab, stool samples, hair, finger nail, ear wax, breath, connective tissue, muscle tissue, nervous tissue, epithelial tissue, cartilage, cancerous sample, and bone.

In some embodiments, the QMAX card includes:
a plurality of scale marks, an imager, and a processing device, wherein:
   (i) at least a portion of the plurality of scale marks comprises the spacers that are periodically arranged.
   (ii) the imager images the scale marks and the device; and
   (iii) the processing device processes one or more images imaged by the imager.

In some embodiments, the processing device comprises a non-transitory computer-readable medium having instructions that, when executed by the processing device, processes the one or more images using one or more image processing algorithms selected from the group consisting of a particle count algorithm, a look up table (LUT) filter, a particle filter, a pattern recognition algorithm, a morphological determination algorithm, a histogram, a line profile, a topographical representation, a binary conversion, a color matching profile, and any combination thereof.

In some embodiments, the QMAX card includes:
i. an imager for imaging the device; and
ii. a processing device for processing one or more images from the imager, wherein the processing device processes the one or more images using an image processing algorithm, and wherein the image processing algorithm includes one or more selected from the group consisting of a particle count algorithm, a look up table (LUT) filter, a particle filter, a pattern recognition algorithm, a morphological determination algorithm, a histogram, a line profile, a topographical representation, a binary conversion, a color matching profile.

In some embodiments, the spacers are in a periodic array.

In some embodiments, the QMAX card includes:
i. an imager for imaging the device;
ii. a processing device for processing one or more images from the imager; and
iii. a non-transitory computer-readable medium comprising machine-executable code that, upon execution by the processing device, implement a method comprising one or more selected from the group consisting of an image acquisition algorithm, an image processing algorithm, a user interface method that (i) facilitates interaction between a user and a computational device and (ii) serves as means for data collection, data transmission and analysis, a communication protocol, and a data processing algorithm.

In some embodiments, the QMAX card includes:
i. an imager for imaging the device;
ii. a processing device for processing one or more images from the imager; and
iii. a non-transitory computer-readable medium comprising machine-executable code that, upon execution by the processing device, implement a method comprising one or more selected from the group consisting of detecting a signal from the sample, correcting raw data based on at least one of:
a. mathematical manipulation,
b. mathematical correction, and
c. one or more calibrations specific for the device or reagents used to examine the sample, including calculating a value, calculating a concentration value, comparing with a baseline, comparing with a threshold, comparing with a standard curve, comparing with historical data, determining the accuracy of a test, determining outlying values or results, determining values or results above or below a normal or acceptable range, determining values or results indicative of an abnormal condition, determining two or more results which, together, indicate the presence of an abnormal condition, curve-fitting, using data as the basis of mathematical or analytical reasoning selected from the group consisting of deductive reasoning, inductive reasoning, Bayesian reasoning.

In some embodiments, the non-transitory computer-readable medium comprises machine-executable code that, upon execution by the processing device, implements a method comprising comparing data with a database to retrieve instructions for a course of action to be performed by the subject.

In some embodiments, the database is stored on the device.

In some embodiments, the QMAX card includes:
i. an imager for imaging the device to generate data; and
ii. a processing device for processing the data from the imager, wherein the processing comprises at least one selected from the group consisting of binning data, transforming data, transforming time domain data by Fourier Transform to frequency domain, and combining the data with additional data.

In some embodiments, the QMAX card includes:
i. an imager for imaging the device to generate data; and
ii. a processing device for processing the data from the imager; and
iii. a non-transitory computer-readable medium comprising machine-executable code that, upon execution by the processing device, implement a method comprising one or more selected from the group consisting of detecting a signal from the sample, correcting raw data based on at least one of:
a. mathematical manipulation,
b. mathematical correction, and
c. one or more calibrations specific for the device or reagents used to examine the sample, including calculating a value, calculating a concentration value, comparing with a baseline, comparing with a threshold, comparing with a standard curve, comparing with historical data, determining the accuracy of a test, determining outlying values or results, determining values or results above or below a normal or acceptable range, determining values or results indicative of an abnormal condition, determining two or more results which, together, indicate the presence of an abnormal condition, curve-fitting, using data as the basis of mathematical or analytical reasoning selected from the group consisting of deductive reasoning, inductive reasoning, Bayesian reasoning.

In some embodiments, the processing may involve comparing the processed data with a database stored in the device to retrieve instructions for a course of action to be performed by the subject.

In some embodiments, the QMAX card includes:
i. an imager for imaging the device to generate data; and
ii. a processing device for processing the data from the imager, wherein the processing comprises determining an accuracy of a test.

In some embodiments, the QMAX card includes:
i. an imager for imaging the device; and
ii. a scanner configured to image different areas of the device,
wherein the spacers comprise a periodic array of spacers.

In some embodiments, the QMAX card includes:
i. an imager for imaging the device; and
ii. a scanner configured to image different areas of the device.

In some embodiments, the analyte is a protein, peptides, DNA, RNA, nucleic acid, molecules, cells, tissues, viruses, nanoparticles with different shapes, or a combination thereof.

In some embodiments, the analyte comprises a stained cell.

In some embodiments, the analyte comprises a stained cell comprising neutrophils, lymphocytes, monocytes, eosinophils, or basophils.

In some embodiments, the analyte comprises a stained analyte, wherein the stain comprising acridine Orange dye.

In some embodiments, the QMAX card includes an imager and a processing device, wherein
(i) the imager images the device; and
(ii) the processing device processes one or more images imaged by the imager and analyzes an analyte.

In some embodiments, the QMAX card includes an imager and a processing device, wherein
(i) the imager images the device; and
(ii) the processing device processes one or more images imaged by the imager, analyzes an analyte and counts a concentration of the analyte.

In some embodiments, the QMAX card includes a measurement device, wherein the measurement device detects and/or quantifies the analyte by measuring a signal related to the analyte, wherein the signal is an optical signal, electrical signal, mechanical signal, chemi-physical signal, or any combination of thereof.

In some embodiments, the QMAX card includes a measurement device, wherein the measurement device detects and/or quantifies the analyte by measuring an optical signal related to the analyte, wherein the optical signal comprising light reflection, scattering, transmission, absorption, spectrum, color, emission, intensity, wavelength, location, polarization, luminescence, fluorescence, electroluminescence, chemiluminescence, electrochemiluminescence, or any combination of thereof.

In some embodiments, the QMAX card includes a measurement device, wherein the measurement device detects and/or quantifies the analyte by measuring an electric signal related to the analyte, wherein the electrical signal comprising charge, current, impedance, capacitance, resistance, or any combination of thereof.

In some embodiments, the QMAX card includes a measurement device, wherein the measurement device detects and/or quantifies the analyte by measuring a mechanical signal related to the analyte, wherein the mechanical signal comprising mechanical wave, sound wave, shock wave, or vibration.

In some embodiments, the QMAX card includes a measurement device, wherein the measurement device detects and/or quantifies the analyte by measuring a chemical-physical signal related to the analyte, wherein he chemical-physical signal includes, but not limited to, PH value, ions, heat, gas bubbles, color change, that are generated in a reaction.

In some embodiments, the QMAX card includes a dry reagent coated on one or both plates.

In some embodiments, the spacer height is approximately the average thickness of RBCs.

In some embodiments, the spacer has a height of 5 micron (μm, also “um” herein) or less.

In some embodiments, the spacer has a height of 10 μm (micron) or less.

In some embodiments, the spacer has a height of 30 μm (micron) or less.

In some embodiments, the spacer has a height of 10 μm (micron) or less, 20 μm (micron) or less, 30 μm (micron) or less, 50 μm (micron) or less, or a range between any two of the values.

In some embodiments, the analyte comprises the cells comprising red blood cells, while blood cells, or platelets.

In some embodiments, the analyte comprises cancer cells, viruses, or bacteria in the blood.

In some embodiments, the spacers are in a periodic array.

In some embodiments, the periodic array comprises a lattice.

In some embodiments, the lattice comprises spacers having a cross-sectional shape selected from the group consisting of a square, a rectangle, a triangle, a hexagon, a polygon, and any combination thereof.

In some embodiments, the lattice comprises two or more spacers having a different cross-sectional shape selected from the group consisting of a square, a rectangle, a triangle, a hexagon, a polygon, and any combination thereof.

In some embodiments, the lattice comprises two or more regions comprising spacers, and the cross-sectional shape of the spacers in each of the two or more regions is independently selected from the group consisting of a square, a rectangle, a triangle, a hexagon, a polygon, and any combination thereof.

In some embodiments, the lattice comprises two or more regions comprising spacers, and the period between each spacer in a first region of the two or more regions is different than the period between each spacer in a second region of the two or more regions.

In some embodiments, the QMAX card includes a plurality of scale markers that are spacers.

In some embodiments, the QMAX card includes one or more scale marks.

In some embodiments, the one or more scale marks are etched, deposited, or printed onto at least one of the first plate and the second plate.

In some embodiments, the one or more scale marks absorb light, reflect light, scatter light, interfere with light, diffract light, emit light, or any combination thereof.

In some embodiments, the QMAX card includes a plurality of scale marks, wherein at least two of the plurality of scale marks are separated by a known distance as measured in a direction that is parallel to a plane of a lateral area of a relevant volume of the sample.

In some embodiments, the QMAX card includes one or more scale marks, wherein at least one of the one or more scale marks is a spacer.

In some embodiments, the QMAX card includes one or more location marks.

In some embodiments, the one or more location marks are spacers.

In some embodiments, the QMAX card includes an imager, wherein the imager images the spacers are used to assist the quantification of a relevant volume of the sample.

In some embodiments, the analyte is selected from the group consisting of a cell, a blood cell, a red blood cell, a white blood cell, a granulocyte, a neutrophil, an eosinophil, a basophil, a lymphocyte, a monocyte, a platelet, a cancer cell, a virus, a bacteria, a fungus, a protein, a nucleic acid, a DNA molecule, an RNA molecule, an miRNA molecule, an mRNA molecule, a hemocyte, a peptide, a polypeptide, a tissue, a nanoparticle, a drug metabolite, a lipid, a carbohydrate, a hormone, a vitamin, a combination thereof, a fragment thereof, and a derivative thereof.

In some embodiments, the uniform thickness of the sample layer in a closed configuration deviates from the spacer height by less than +/−5%.

In some embodiments, the sample deposited on the plate in an open configuration is deposited directly from a subject to the plate without using any transferring devices.

In some embodiments, the sample deposited on the plate in an open configuration has an amount of the sample that is unknown.

In some embodiments, the uniform thickness of the sample layer in a closed configuration is used to calculate a volume of a sample that is regulated by the plates and the spacers of the device.

In some embodiments, the QMAX card includes one or a plurality of binding sites that on one or both plate sample contact surfaces of the device, and wherein each of the binding sites selectively binds and immobilizes an analyte or analytes that is in or is suspected in a sample.

In some embodiments, the QMAX card includes one or a plurality of storage sites on one or both plate sample contact surfaces, wherein each of the storage sites stores a reagent or reagents, wherein the reagent(s) dissolve and diffuse in a sample when the device is in a closed configuration.

In some embodiments, the QMAX card includes one or a plurality of amplification sites on one or both of the sample contact surfaces of the device, wherein each of the amplification sites is capable of amplifying a signal from an analyte in a sample or a label of the analyte when the analyte or the label is within 500 nm from an amplification site.

In some embodiments, the QMAX card includes a first assay site on the sample contact area for assessing a first analyte, and in and assaying a second analyte in the second predetermined assay site.

In some embodiments, the QMAX card includes a pair of electrodes on the sample contact area, wherein an analyte assay area is between the electrodes.

In some embodiments, the spacer is a height that is configured to make a reaction of the analyte with a reagent to be saturated in less than 60 seconds.

In some embodiments, one or both of the plate further comprises, on its surface, a plurality of assay sites, wherein the distance between the edges of neighboring assay sites is substantially larger than the thickness of the uniform thickness layer when the plates are in the closed position, wherein at least a part of the uniform thickness layer is over the assay sites, and wherein the sample has one or a plurality of analytes that are capable of diffusing in the sample.

In some embodiments, the first plate has, on its surface, at least two neighboring analyte assay sites that are not separated by a distance that is substantially larger than the thickness of the uniform thickness layer when the plates are in the closed position, wherein at least a part of the uniform thickness layer is over the assay sites, and wherein the sample has one or a plurality of analytes that are capable of diffusing in the sample.

In some embodiments, one or both of the plate further comprises, on its surface, a plurality of assay sites, wherein the distance between the edges of neighboring assay sites is configured that in a time of 30 mins or less, the reaction at each site occurs independently, without a fluidic barrier to fluidically separate a sample into different isolation liquid pockets.

In some embodiments, the QMAX card includes a mobile communication device that communicates with the remote location via a Wi-Fi or cellular network.

In some embodiments, the QMAX card includes a mobile communication device that is a mobile phone.

In some embodiments, the QMAX card includes a mobile communication device that receives a prescription, diagnosis or a recommendation from a medical professional at a remote location.

In some embodiments, the analyte is measured by using an label that is selected from the group consisting of a light-emitting label, a fluorescent label, a dye, a quantum dot, a luminescent label, electro-luminescent label, a chemical-luminescent label, a bead, an electromagnetic radiation emitter, an optical label, an electric label, enzymes that can be used to generate an optical or electrical signal, a nanoparticle, a colorimetric label, an enzyme-linked reagent, a multicolor reagent, and an avidin-streptavidin associated detection reagent.

In some embodiments, the analyte is measured by using an label comprising a fluorescent label that is selected from the group consisting of IRDye800CW, Alexa 790, Dylight 800, fluorescein, fluorescein isothiocyanate, succinimidyl esters of carboxyfluorescein, succinimidyl esters of fluorescein, 5-isomer of fluorescein dichlorotriazine, caged carboxyfluorescein-alanine-carboxamide, Oregon Green 488, Oregon Green 514, Lucifer Yellow, acridine Orange, rhodamine, tetramethylrhodamine, Texas Red, propidium iodide, JC-1 (5,5′,6,6′-tetrachloro-1,1 ′,3,3′-tetraethylbenzimidazoylcarbocyanine iodide), tetrabromorhodamine 123, rhodamine 6G, TMRM (tetramethyl rhodamine methyl ester), TMRE (tetramethyl rhodamine ethyl ester), tetramethylrosamine, rhodamine B, 4-dimethylaminotetramethylrosamine, green fluorescent protein, blue-shifted green fluorescent protein, cyan-shifted green fluorescent protein, red-shifted green fluorescent protein, yellow-shifted green fluorescent protein, 4-acetamido-4′-isothiocyanatostilbene-2,2′ di sulfonic acid, acridine, acridine isothiocyanate, 5-(2′-aminoethyl)aminonaphthalene-1-sulfonic acid (EDANS), 4-amino-N-[3-vinylsulfonyl)phenyl]naphth-alimide-3,5 disulfonate, N-(4-anilino-1-naphthyl)maleimide, anthranilamide, 4,4-difluoro-5-(2-thienyl)-4-bora-3a,4a diaza-5-indacene-3-propioni-c acid BODIPY, cascade blue, Brilliant Yellow, coumarin, 7-amino-4-methylcoumarin (AMC, Coumarin 120),7-amino-4-trifluoromethylcoumarin (Coumarin 151), cyanine dyes, cyanosine, 4′,6-diaminidino-2-phenylindole (DAPI), 5′,5″-dibromopyrogallol-sulfonaphthalein (Bromopyrogallol Red), 7-diethylamino-3-(4′-isothiocyanatophenyl)-4-methyl c oum arin, di ethyl enetri aamine pentaacetate, 4,4′-diisothioc yanatodihydro-stilbene-2-,2′-di sulfonic acid, 4,4′-diisothiocyanatostilbene-2,2′-disulfonic acid, 5-(dimethylaminolnaphthalene-1-sulfonyl chloride (DNS, dansylchloride), 4-dimethylaminophenylazophenyl-4′-isothiocyanate (DABITC), eosin, eosin isothiocyanate, erythrosin, erythrosin B, isothiocyanate, ethidium, fluorescein, 5-carboxyfluorescein (FAM),5-(4,6-dichlorotriazin-2-yl)amino-fluorescein (DTAF), 2′,7′ dimethoxy-4′ 5′-dichloro-6-carboxyfluorescein (JOE), fluorescein isothiocyanate, QFITC, (XRITC), fluorescamine, IR144, IR1446, Malachite Green isothiocyanate, 4-methylumbelli-feroneortho cresolphthalein, nitrotyrosine, pararosaniline, Phenol Red, B-phycoerythrin, o-phthaldialdehyde, pyrene, pyrene butyrate, succinimidyl 1-pyrene, butyrate quantum dots, Reactive Red 4 (Cibacron™ Brilliant Red 3B-A) rhodamine, 6-carboxy-X-rhodamine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of sulforhodamine 101 (Texas Red), N,N,N′,N′-tetramethyl-6-carboxyrhodamine (TAMRA), tetramethyl rhodamine, tetramethyl hodamine isothiocyanate (TRITC), riboflavin, 5-(2′-aminoethyl) aminonaphthalene-1-sulfonic acid (EDANS), 4-(4′-dimethylaminophenylazo)benzoic acid (DABCYL), rosolic acid, CAL Fluor Orange 560, terbium chelate derivatives, Cy 3, Cy 5, Cy 5.5, Cy 7, IRD 700, IRD 800, La Jolla Blue, phthalo cyanine, naphthalo cyanine, coumarin, xanthene dyes such as rhodols, resorufins, bimanes, acridines, isoindoles, dansyl dyes, aminophthalic hydrazides such as luminol, isoluminol derivatives, aminophthalimides, aminonaphthalimides, aminobenzofurans, aminoquinolines, dicyanohydroquinones, fluorescent europium, terbium complexes, a green fluorescent protein (GFP), a GFP derived from Aequoria victoria, a “humanized” derivative such as Enhanced GFP, a GFP from Renilla reniformis, Renilla mulleri, Ptilosarcus guernyi, “humanized” recombinant GFP (hrGFP), a combination thereof, a fragment thereof, and a derivative thereof.

In some embodiments, the sample is blood, and the analyte is one or more selected from the group consisting of white blood cells, red blood cells, and platelets.

In some embodiments, the QMAX card includes scale marks, wherein the scale marks comprise spacers that are periodically arranged.

In some embodiments, the spacers are arranged in a periodic array, and wherein the periodic array has a rectangular lattice.

In some embodiments, the spacers are arranged in a periodic array, and wherein the periodic array has a triangular lattice, square lattice, diamond lattice, pentagonal lattice, hexagonal lattice, heptagonal lattice, octagonal lattice, nonagonal lattice, or a decagonal lattice.

Hand Pressing

For the devices, apparatus, systems, and methods herein disclosed, human hands can be used for manipulating or handling or the plates and/or samples. In some embodiments, human hands can be used to press the plates into a closed configuration; In some embodiments, human hands can be used to press the sample into a thin layer. The manners in which hand pressing is employed are described and/or summarized in PCT Application (designating U.S.) Nos. PCT/US2016/045437 filed on Aug. 10, 2016 and PCT/US0216/051775 filed on Sep. 14, 2016, and in US Provisional Application Nos. 62/431,639 filed on Dec. 9, 2016, 62/456,287 filed on Feb. 8, 2017, 62/456,065 filed on Feb. 7, 2017, 62/456,504 filed on Feb. 8, 2017, and 62/460,062 filed on Feb. 16, 2017, which are all hereby incorporated by reference by their entireties.

In some embodiments, human hand can be used to manipulate or handle the plates of the QMAX device. In certain embodiments, the human hand can be used to apply an imprecise force to compress the plates from an open configuration to a closed configuration. In certain embodiments, the human hand can be used to apply an imprecise force to achieve high level of uniformity in the thickness of the sample (e.g. less than 5%, 10%, 15%, or 20% variability).

Smartphone

The devices, apparatus, systems, and methods herein disclosed can be used with a mobile device, such as but not limited to a smartphone. The smartphone detection technology is herein disclosed, or listed, described, and/or summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, U.S. Provisional Application No. 62/456,287, which was filed on Feb. 8, 2017, and U.S. Provisional Application No. 62/456,504, which was filed on Feb. 8, 2017, all of which applications are incorporated herein in their entireties for all purposes.

In some embodiments, the smartphone comprises a camera, which can be used to capture images or the sample when the sample is positioned in the field of view of the camera (e.g. by an adaptor). In certain embodiments, the camera includes one set of lenses (e.g. as in iPhone™ 6). In certain embodiments, the camera includes at least two sets of lenses (e.g. as in iPhone™ 7). In some embodiments, the smartphone comprises a camera, but the camera is not used for image capturing.

In some embodiments, the smartphone comprises a light source such as but not limited to LED (light emitting diode). In certain embodiments, the light source is used to provide illumination to the sample when the sample is positioned in the field of view of the camera (e.g. by an adaptor). In some embodiments, the light from the light source is enhanced, magnified, altered, and/or optimized by optical components of the adaptor.

In some embodiments, the smartphone comprises a processor that is configured to process the information from the sample. The smartphone includes software instructions that, when executed by the processor, can enhance, magnify, and/or optimize the signals (e.g. images) from the sample. The processor can include one or more hardware components, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

In some embodiments, the smartphone comprises a communication unit, which is configured and/or used to transmit data and/or images related to the sample to another device. Merely by way of example, the communication unit can use a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof.

In some embodiments, the smartphone is an iPhone™, an Android™ phone, or a Windows™ phone.

Cloud

The devices, apparatus, systems, and methods herein disclosed can be used with cloud storage and computing technologies. The related cloud technologies are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, U.S. Provisional Application No. 62/456,287, which was filed on Feb. 8, 2017, and U.S. Provisional Application No. 62/456,504, which was filed on Feb. 8, 2017, all of which applications are incorporated herein in their entireties for all purposes.

In some embodiments, the cloud storage and computing technologies can involve a cloud database. Merely by way of example, the cloud platform can include a private cloud, a public cloud, a hybrid cloud, a community cloud, a distributed cloud, an inter-cloud, a multi-cloud, or the like, or any combination thereof. In some embodiments, the mobile device (e.g. smartphone) can be connected to the cloud through any type of network, including a local area network (LAN) or a wide area network (WAN).

In some embodiments, the data (e.g. images of the sample) related to the sample is sent to the cloud without processing by the mobile device and further analysis can be conducted remotely. In some embodiments, the data related to the sample is processed by the mobile device and the results are sent to the cloud. In some embodiments, both the raw data and the results are transmitted to the cloud.

It is to be noted that the terms “first,” “second,” and the like as used herein do not denote any order, quantity, or importance, but rather are used to distinguish one element from another. The terms “a” and “an do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and independently combinable.

It is appreciated that the device, system, and method in this disclosure may apply to various liquid samples, including a blood sample, with or without apparent modification. Such modification should be understood as being within the scope of this disclosure.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described.

The term “a,” “an,” or “the” cover both the singular and the plural reference, unless the context clearly dictates otherwise. The terms “comprise,” “have,” “include,” and “contain” are open-ended terms, which means “include but not limited to,” unless otherwise indicated.

The “substantially uniform thickness” means a thickness that is constant or only fluctuates around a mean value, for example, by no more than 10%, and preferably no more than 5%.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Aspects

1. An apparatus for assaying an analyte in multiple samples, comprising:
a cartridge to receive a sample, wherein the cartridge comprises a first plate and a second plate that are movable relative to each other into different configurations, including an open configuration and a closed configuration;
a transporter to position and advance the cartridge;
a first dispenser to deposit a sample on one of the two plates of the cartridge when the cartridge is at the open configuration;
a press to compress the first and second plates of the cartridge from the open configuration to the closed configuration, making the sample between the first and second plates into a uniformly thick layer; and
an imager to image the uniformly thick layer;
wherein one or both of the two plates are flexible; each of the plates has, on its respective surface, a sample contact area for contacting the sample; and one or both of the two plates comprise spacers that are fixed with a respective plate;
wherein the spacers have pillar shape and a predetermined uniform height of 200 μm or less, and a predetermined inter-spacer distance, and wherein at least one of the spacers is inside the sample contact area;
wherein the open configuration is the configuration, in which: the two plates are separated apart, the spacing between the plates is not regulated by the spacers, and the sample is deposited on one or both of the plates; and
wherein the closed configuration is the configuration, which is configured after the sample deposition in the open configuration; and in the closed configuration: at least part of the sample is compressed by the two plates into a layer of uniform thickness and is substantially stagnant relative to the plates, wherein the uniform thickness of the layer is confined by the inner surfaces of the two plates and is regulated by the plates and the spacers.
   2. The apparatus of Aspect 1, further comprising a cartridge feeder to place the cartridge on the transporter.
   3. The apparatus of Aspect 1, further comprising a second dispenser to dispense a reagent to contact the sample.
   4. The apparatus of Aspect 1, wherein the reagents are coated on one or both of the two plates.
   5. The apparatus of Aspect 1, wherein the fourth power of the inter-spacer-distance (ISD) divided by the thickness of the flexible plate (h) and the Young's modulus (E) of the flexible plate, ISD4/(hE), is equal to or less than 5×10⁶ m ³/GPa; and the thickness of the flexible plate times the Young's modulus of the flexible plate is in the range 60 to 750 GPa-μm.
   6. The apparatus of Aspect 1, further comprising a docking apparatus to position the cartridge in a stationary position.
   7. The apparatus of Aspect 1, wherein the docking apparatus positions the cartridge in the stationary position in the fourth station.
   8. The apparatus of Aspect 1, wherein the first and second plates are connected by a hinge and are configured to be changed from the open configuration to the closed configuration by folding the plates along the hinge.
   9. The apparatus of Aspect 1, wherein the first and second plates are not connected by a hinge.
   10. A method of executing an assay, comprising:
placing a cartridge on a transporter with the cartridge in an open configuration;
depositing a sample on the cartridge with a first dispenser;
closing, using a press, the first plate and the second plate of the cartridge into a closed configuration, make the sample between the first and second plates into a uniformly thick layer;
imaging the sample at the closed configuration with an imager to obtain an image; and
analyzing the image with an analyzer to determine a property of the sample.
   11. The method of Aspect 10, wherein:
the base layer is formed in a first station;
the sample is deposited on the cartridge in a second station;
the reagent and sample are contacted in the second station;
the cover layer and the assay card are formed in a third station; and
the sample is imaged in a fourth station.
   12. The method of any one of Aspects 10-11, further comprising positioning the cartridge in a stationary position prior to imaging the sample.
   13. The method of any one of Aspects 10-12, wherein the cartridge is positioned in the stationary position in the fourth station.
   14. The method of any one of Aspects 10-13, further comprising docking the cartridge in a stationary position prior to imaging with a docking apparatus.
   15. The method of any one of Aspects 10-14, further comprising moving the cartridge in a horizontal or linear direction during imaging with a moveable stage.
   16. The apparatus or method of any one of Aspects 1-15, wherein:
the cartridge comprises a spacer fixed to a sample contact area of the cartridge;
the spacer includes a pillar shape, a substantially flat top surface, a predetermined substantially uniform height and a predetermined inter-spacer distance;
the inter-spacer distance is a distance between two neighboring spacers;
a Young's modulus of the spacer multiplied by the filling factor of the spacer is equal to or larger than 2 MPa; and
the filling factor is the ratio of a spacer contact area to a total cartridge area.
   17. The apparatus or method of any one of Aspects 1-16, further comprising a docking apparatus to position the cartridge in a stationary position.
   18. The apparatus or method of any one of Aspects 1-17, wherein the docking apparatus comprises a mechanical arm.
   19. The apparatus or method of any one of Aspects 1-18, further comprising a moveable stage for moving the cartridge in a horizontal and vertical direction.
   20. The apparatus or method of any one of Aspects 1-19, wherein the moveable stage comprises a motorized stage.
   21. The apparatus or method of any one of Aspects 1-20, wherein the spacer is a plurality of spacers.
   22. The apparatus or method of any one of Aspects 1-21, wherein the uniformly thick layer is confined by a sample contact surface of the cartridge and the film and is regulated by the cartridge, film, and the spacer.
   23. The apparatus or method of any one of Aspects 1-22, wherein the image is analyzed in a fifth station.
   24. The apparatus or method of any one of Aspects 1-23, wherein the image is analyzed remotely.
   25. The apparatus or method of any one of Aspects 1-24, wherein the transporter comprises a conveyor belt to linearly transport the cartridge.
   26. The apparatus or method of any one of Aspects 1-25, wherein the transporter comprises a conveyor belt to linearly advance the cartridge, the conveyor belt including a carrier plate to removably receive the cartridge.
   27. The apparatus or method of any one of Aspects 1-26, wherein the carrier plate includes a recess to retain the cartridge in place.
   28. The apparatus or method of any one of Aspects 1-27, wherein the transporter comprises a rail to linearly advance the cartridge.
   29. The apparatus or method of any one of Aspects 1-28, wherein the transporter comprises a rotatable plate to annularly advance the cartridge.
   30. The apparatus or method of any one of Aspects 1-29, wherein the rotatable plate positions the cartridge at an angle with respect to the imager in the fourth station to provide the imager a field of view of an area of the sample to image.
   31. The apparatus or method of any one of Aspects 1-30, wherein the rotatable plate positions the cartridge at a plurality of angles with respect to the imager to provide the imager multiple fields of views of different areas of the sample to image.
   32. The apparatus or method of any one of prior Aspects, wherein the rotatable plate comprises a carrier plate to removably receive the cartridge.
   33. The apparatus or method of any one of Aspects 1-32, wherein the carrier plate includes a recess to retain the cartridge in place.
   34. The apparatus or method of any one of Aspects 1-33, wherein the rotatable plate comprises a recess to receive and retain the cartridge in place.
   35. The apparatus or method of any one of Aspects 1-34, wherein the transporter comprises an opening to allow the imager to image the sample through the transporter.
   36. The apparatus or method of any one of Aspects 1-35, wherein the opening is disposed adjacent the cartridge.
   37. The apparatus or method of any one of Aspects 1-36, wherein the cartridge feeder is oriented to the cartridge at an angle from 0.1 to 179.9 degrees.
   38. The apparatus or method of any one of Aspects 1-37, wherein the cartridge feeder is normal to the cartridge.
   39. The apparatus or method of any one of Aspects 1-38, wherein the first dispenser is oriented to the cartridge at an angle from 60 to 120 degrees.
   40. The apparatus or method of any one of Aspects 1-39, wherein the first dispenser is normal to the cartridge.
   41. The apparatus or method of any one of Aspects 1-40, wherein the first dispenser comprises a syringe to dispense the sample.
   42. The apparatus or method of any one of Aspects 1-41, wherein the first dispenser comprises a pipette to dispense the sample.
   43. The apparatus or method of any one of Aspects 1-42, wherein the second dispenser is oriented to the cartridge at an angle from 60 to 120 degrees.
   44. The apparatus or method of any one of Aspects 1-43, wherein the second dispenser is normal to the cartridge.
   45. The apparatus or method of any one of Aspects 1-44, wherein the second dispenser comprises a syringe to dispense the reagent.
   46. The apparatus or method of any one of Aspects 1-45, wherein the second dispenser comprises a pipette to dispense the reagent.
   47. The apparatus or method of any one of Aspects 1-46, wherein the film feeder is oriented to the cartridge at an angle from 0.1 to 179.9 degrees.
   48. The apparatus or method of any one of Aspects 1-47, wherein the film feeder is normal to the cartridge.
   49. The apparatus or method of any one of Aspects 1-48, wherein the press comprises a mechanical press including a rubber material, the mechanical press to apply a uniform pressure on the film.
   50. The apparatus or method of any one of Aspects 1-49, wherein the press comprises an air cushion press that applies a uniform pressure on the film.
   51. The apparatus or method of any one of Aspects 1-50, wherein the press is normal to the cartridge.
   52. The apparatus or method of any one of Aspects 1-51, wherein the cartridge is disposed between the imager and the transporter.
   53. The apparatus or method of any one of Aspects 1-52, wherein the transporter is disposed between the imager and the cartridge.
   54. The apparatus or method of any one of Aspects 1-53, wherein the imager is oriented to the cartridge at an angle from 60 to 120 degrees in the fourth station.
   55. The apparatus or method of any one of Aspects 1-54, wherein the imager is normal to the cartridge in the fourth station.
   56. The apparatus or method of any one of Aspects 1-55, wherein the imager includes a microscope to inspect the sample.
   57. The apparatus or method of any one of Aspects 1-56, wherein the imager includes a camera to image the sample.
   58. The apparatus or method of any one of Aspects 1-57, wherein the camera is a single camera.
   59. The apparatus or method of any one of Aspects 1-58, wherein the camera comprises multiple cameras.
   60. The apparatus or method of any one of Aspects 1-59, wherein the docking apparatus comprises a mechanical arm.
   61. An apparatus, including:
a cartridge to receive a sample;
a transporter to position and advance the cartridge;
a cartridge feeder to place the cartridge on the transporter;
a first dispenser to deposit a sample on the cartridge;
a second dispenser to dispense a reagent to contact the sample;
a film to cover the sample;
a film feeder to place the film on the sample;
a press to compress the sample between the film and the cartridge into a uniformly thick layer; and
an imager to image the uniformly thick layer.
   62. A system of making an assay card and executing an assay, comprising:
the apparatus of any of Aspects 1-61;
   wherein:
   the cartridge feeder places the cartridge on the transporter in a first station to form a base layer of an assay card;
   the first dispenser deposits a sample on the cartridge in a second station;
   the second dispenser dispenses a reagent to contact the sample on the cartridge in the second station;
   the film feeder places a film on the cartridge to cover the sample and form a cover layer of the assay card in a third station;
   the press uniformly compresses the sample between the cartridge and the film into a uniformly thick layer to form the assay card in the third station;
   the imager images the uniformly thick layer to obtain an image for analysis in a fourth station; and
   the transporter positions and advances the cartridge along each of the stations.
      63. The system of Aspect 62, further comprising a docking apparatus to position the cartridge in a stationary position.
      64. The system of Aspect 63, wherein the docking apparatus positions the cartridge in the stationary position in the fourth station.
      65. A method of making an assay card and executing an assay, comprising:
placing a cartridge on a transporter with the cartridge feeder to form a base layer of an assay card;
depositing a sample on the cartridge with a first dispenser;
contacting the reagent and the sample with a second dispenser;
placing a film on the cartridge with a film feeder to cover the sample and form a cover layer of the assay card;
uniformly pressing the film against the cartridge to compress the sample between the cartridge and the film into a uniformly thick layer and form the assay card;
imaging the sample with an imager to obtain an image; and
analyzing the image with an analyzer to determine a property of the sample.
   66. The method of Aspect 65, wherein:
the base layer is formed in a first station;
the sample is deposited on the cartridge in a second station;
the reagent and sample are contacted in the second station;
the cover layer and the assay card are formed in a third station; and
the sample is imaged in a fourth station.
   67. The method of Aspect 65, further comprising positioning the cartridge in a stationary position prior to imaging the sample.
   68. The method of Aspect 67, wherein the cartridge is positioned in the stationary position in the fourth station.
   69. The method of Aspect 65, further comprising docking the cartridge in a stationary position prior to imaging with a docking apparatus.
   70. The method of Aspect 65, further comprising moving the cartridge in a horizontal or linear direction during imaging with a moveable stage.
   71. The apparatus or method of any one of Aspects 1-70, wherein:
the cartridge comprises a spacer fixed to a sample contact area of the cartridge;
the spacer includes a pillar shape, a substantially flat top surface, a predetermined substantially uniform height and a predetermined inter-spacer distance;
the inter-spacer distance is a distance between two neighboring spacers;
a Young's modulus of the spacer multiplied by the filling factor of the spacer is equal to or larger than 2 MPa; and
the filling factor is the ratio of a spacer contact area to a total cartridge area.
   72. The apparatus or method of any one of prior Aspects, further comprising a docking apparatus to position the cartridge in a stationary position.
   73. The apparatus or method of any one of Aspects 1-72, wherein the docking apparatus comprises a mechanical arm.
   74. The apparatus or method of any one of Aspects 1-73, further comprising a moveable stage for moving the cartridge in a horizontal and vertical direction.
   75. The apparatus or method of any one of prior Aspects, wherein the moveable stage comprises a motorized stage.
   76. The apparatus or method of any one of Aspects 1-75, wherein the spacer is a plurality of spacers.
   77. The apparatus or method of any one of Aspects 1-76, wherein the uniformly thick layer is confined by a sample contact surface of the cartridge and the film and is regulated by the cartridge, film, and the spacer.
   78. The apparatus or method of any one of Aspects 1-77, wherein the image is analyzed in a fifth station.
   79. The apparatus or method of any one of Aspects 1-78, wherein the image is analyzed remotely.
   80. The apparatus or method of any one of Aspects 1-79, wherein the transporter comprises a conveyor belt to linearly transport the cartridge.
   81. The apparatus or method of any one of Aspects 1-80, wherein the transporter comprises a conveyor belt to linearly advance the cartridge, the conveyor belt including a carrier plate to removably receive the cartridge.
   82. The apparatus or method of any one of Aspects 1-81, wherein the carrier plate includes a recess to retain the cartridge in place.
   83. The apparatus or method of any one of Aspects 1-82, wherein the transporter comprises a rail to linearly advance the cartridge.
   84. The apparatus or method of any one of Aspects 1-83, wherein the transporter comprises a rotatable plate to annularly advance the cartridge.
   85. The apparatus or method of any one of Aspects 1-84, wherein the rotatable plate positions the cartridge at an angle with respect to the imager in the fourth station to provide the imager a field of view of an area of the sample to image.
   86. The apparatus or method of any one of Aspects 1-85, wherein the rotatable plate positions the cartridge at a plurality of angles with respect to the imager to provide the imager multiple field of views of different areas of the sample to image.
   87. The apparatus or method of any one of Aspects 1-86, wherein the rotatable plate comprises a carrier plate to removably receive the cartridge.
   88. The apparatus or method of any one of Aspects 1-87, wherein the carrier plate includes a recess to retain the cartridge in place.
   89. The apparatus or method of any one of Aspects 1-88, wherein the rotatable plate comprises a recess to receive and retain the cartridge in place.
   90. The apparatus or method of any one of Aspects 1-89, wherein the transporter comprises an opening to allow the imager to image the sample through the transporter.
   91. The apparatus or method of any one of Aspects 1-90, wherein the opening is disposed adjacent the cartridge.
   92. The apparatus or method of any one of Aspects 1-91, wherein the cartridge feeder is oriented to the cartridge at an angle from 0.1 to 179.9 degrees.
   93. The apparatus or method of any one of Aspects 1-92, wherein the cartridge feeder is normal to the cartridge.
   94. The apparatus or method of any one of Aspects 1-93, wherein the first dispenser is oriented to the cartridge at an angle from 60 to 120 degrees.
   95. The apparatus or method of any one of Aspects 1-94, wherein the first dispenser is normal to the cartridge.
   96. The apparatus or method of any one of Aspects 1-95, wherein the first dispenser comprises a syringe to dispense the sample.
   97. The apparatus or method of any one of Aspects 1-96, wherein the first dispenser comprises a pipette to dispense the sample.
   98. The apparatus or method of any one of Aspects 1-97, wherein the second dispenser is oriented to the cartridge at an angle from 60 to 120 degrees.
   99. The apparatus or method of any one of Aspects 1-98, wherein the second dispenser is normal to the cartridge.
   100. The apparatus or method of any one of Aspects 1-99, wherein the second dispenser comprises a syringe to dispense the reagent.
   101. The apparatus or method of any one of Aspects 1-100, wherein the second dispenser comprises a pipette to dispense the reagent.
   102. The apparatus or method of any one of Aspects 1-101, wherein the film feeder is oriented to the cartridge at an angle from 0.1 to 179.9 degrees.
   103. The apparatus or method of any one of Aspects 1-102, wherein the film feeder is normal to the cartridge.
   104. The apparatus or method of any one of Aspects 1-103, wherein the press comprises a mechanical press including a rubber material, the mechanical press to apply a uniform pressure on the film.
   105. The apparatus or method of any one of Aspects 1-104, wherein the press comprises an air cushion press that applies a uniform pressure on the film.
   106. The apparatus or method of any one of Aspects 1-105, wherein the press is normal to the cartridge.
   107. The apparatus or method of any one of Aspects 1-108, wherein the cartridge is disposed between the imager and the transporter.
   108. The apparatus or method of any one of Aspects 1-107, wherein the transporter is disposed between the imager and the cartridge.
   109. The apparatus or method of any one of Aspects 1-108, wherein the imager is oriented to the cartridge at an angle from 60 to 120 degrees in the fourth station.
   110. The apparatus or method of any one of Aspects 1-109, wherein the imager is normal to the cartridge in the fourth station.
   111. The apparatus or method of any one of Aspects 1-110, wherein the imager includes a microscope to inspect the sample.
   112. The apparatus or method of any one of Aspects 1-111, wherein the imager includes a camera to image the sample.
   113. The apparatus or method of any one of Aspects 1-112, wherein the camera is a single camera.
   114. The apparatus or method of any one of Aspects 1-113, wherein the camera comprises multiple cameras.
   115. The apparatus or method of any one of Aspects 1-114, wherein the docking apparatus comprises a mechanical arm.
   116. The apparatus of any prior Aspect, wherein the apparatus further comprises, on one or both plates, a dry binding site that has a predetermined area, wherein the dry binding site binds to and immobilizes an analyte in the sample.
   117. The apparatus of any prior Aspect, wherein the apparatus further comprises, on one or both plates, a releasable dry reagent and a release time control material that delays the time that the releasable dry regent is released into the sample.
   118. The apparatus of Aspect 4, wherein the release time control material delays the time that the dry regent starts is released into the sample by at least 3 seconds.
   119. The apparatus of Aspect 2, wherein the regent comprises anticoagulant and/or staining reagent(s).
   120. The apparatus of any prior Aspect, wherein the apparatus further comprises, on one or both plates, one or a plurality of dry binding sites and/or one or a plurality of reagent sites.
   121. The apparatus of Aspect 1, wherein the apparatus further comprises a dry reagent coated on one or both plates.
   122. The apparatus of any prior apparatus Aspect, wherein the ratio of the inter-spacing distance of the spacers to the average width of the spacer is 2 or larger, and the filling factor of the spacers multiplied by the Young's modulus of the spacers is 20 MPa or larger.
   123. The apparatus of any prior apparatus Aspect, wherein the analyte is stained.
   124. The apparatus of any prior Aspect, wherein for spacers regulating the layer of uniform thickness, the Young's modulus of the spacers times the filling factor of the spacers is equal or larger than 20 MPa, wherein the filling factor is the ratio of the spacer contact area to the total plate area.
   125. The apparatus of any prior Aspect, wherein the average thickness of the layer of uniform thickness is in the range of 1.8 μm to 2.6 μm and the sample is whole blood without a dilution by another liquid.
   126. The apparatus of any prior Aspect, wherein the thickness of one of the plates times the Young's modulus of the plate is in the range 60 to 750 GPa-μm.
   127. The apparatus of any prior Aspect, wherein for a flexible plate, the fourth power of the inter-spacer-distance (ISD) divided by the thickness of the flexible plate (h) and the Young's modulus (E) of the flexible plate, ISD⁴/(hE), is equal to or less than 10⁵ μm³/GPa,
   128. The apparatus of any prior Aspect, wherein one or both plates comprises a location marker, either on a surface of or inside the plate, that provide information of a location of the plate.
   129. The apparatus of any prior Aspect, wherein one or both plates comprises a scale marker, either on a surface of or inside the plate, that provide information of a lateral dimension of a structure of the sample and/or the plate.
   130. The apparatus of any prior Aspect, wherein one or both plates comprises an imaging marker, either on surface of or inside the plate, that assists an imaging of the sample.
   131. The apparatus of any prior Aspect, wherein the spacers functions as a location marker, a scale marker, an imaging marker, or any combination of thereof.
   132. The apparatus of any prior Aspect, wherein the ratio of the inter-spacing distance of the spacers to the average width of the spacer is 2 or larger, and the filling factor of the spacers multiplied by the Young's modulus of the spacers is 20 MPa or larger, and the thickness of one of the plates times the Young's modulus of the plate is in the range 60 to 550 GPa-μm.
   133. The apparatus of any prior Aspect, wherein the fourth power of the inter-spacer-distance (ISD) divided by the thickness of the flexible plate (h) and the Young's modulus (E) of the flexible plate, ISD4/(hE), is equal to or less than 10\hat{ }6 μm\hat{ }3/GPa; and the thickness of the flexible plate times the Young's modulus of the flexible plate is in the range 60 to 750 GPa-μm.
   134. The apparatus of any prior Aspect, the spacer height is selected in the range of 1.8 to 50 μm, the IDS is 120 μm or less, the fourth power of the inter-spacer-distance (IDS) divided by the thickness (h) and the Young's modulus (E) of the flexible plate (ISD⁴/(hE)) is 5×10⁵ μm³/GPa or less; the thickness of the flexible plate times the Young's modulus of the flexible plate is in the range of 100 to 550 GPa-μm.
   135. The apparatus of any prior Aspect, wherein the average thickness of the layer of uniform thickness is in the range of 2.6 μm to 3.8 μm and the sample is blood.
   136. The apparatus of any prior Aspect, wherein the average thickness of the layer of uniform thickness is in the range of 1.8 μm to 3.8 μm and the sample is whole blood without a dilution by another liquid.
   137. The apparatus of any prior Aspect, wherein the average thickness of the layer of uniform thickness is about equal to a minimum dimension of an analyte in the sample.
   138. The apparatus of any prior Aspect, wherein the inter-spacer distance is in the range of 7 μm to 50 μm.
   139. The apparatus of any prior Aspect, wherein the inter-spacer distance is in the range of 50 μm to 120 μm.
   140. The apparatus of any prior Aspect, wherein the inter-spacer distance is in the range of 120 μm to 200 μm.
   141. The apparatus of any prior Aspect, wherein the inter-spacer distance is substantially periodic.
   142. The apparatus of any prior Aspect, wherein the spacers are pillars with a cross-sectional shape selected from round, polygonal, circular, square, rectangular, oval, elliptical, or any combination of the same.
   143. The apparatus of any prior Aspect, wherein the spacers have are pillar shape and have a substantially flat top surface, wherein, for each spacer, the ratio of the lateral dimension of the spacer to its height is at least 1.
   144. The apparatus of any prior Aspect, wherein each spacer has the ratio of the lateral dimension of the spacer to its height is at least 1.
   145. The apparatus of any prior Aspect, wherein the minimum lateral dimension of spacer is less than or substantially equal to the minimum dimension of an analyte in the sample.
   146. The apparatus of any prior Aspect, wherein the minimum lateral dimension of spacer is in the range of 0.5 μm to 100 μm.
   147. The apparatus of any prior Aspect, wherein the apparatus further comprises a dry reagent on the plate, and wherein the reagent comprise the detectable label selected from the group consisting of: a fluorescent label, a colorimetric label, a chemiluminescent label, an enzyme-linked reagent, a multicolor reagent, and an avidin-streptavidin associated detection reagent.
   148. The apparatus of any prior Aspect, wherein the spacers have pillar shape, a substantially flat top surface, a predetermined substantially uniform height, and a predetermined constant inter-spacer distance that is at least about 2 times larger than the size of the analyte, wherein the Young's modulus of the spacers times the filling factor of the spacers is equal or larger than 20 MPa, wherein the filling factor is the ratio of the spacer contact area to the total plate area, and wherein, for each spacer, the ratio of the lateral dimension of the spacer to its height is at least 1 (one), wherein the fourth power of the inter-spacer-distance (ISD) divided by the thickness (h) and the Young's modulus (E) of the flexible plate (ISD4/(hE)) is 5×10⁶ μm3/GPa or less.
   149. The apparatus of any prior Aspect, wherein the sample is strained, wherein the staining uses Romanowsky's stain, Leishman stain, May-Grunwald stain, Giemsa stain, Jenner's stain, Wright's stain, or any combination of the same
   150. The apparatus of any prior Aspect, wherein the sample is a stained, wherein the stain is immunohistochemical (IHC) staining.
   151. The apparatus of any prior Aspect, wherein the sample is a biological sample, an environmental sample, a chemical sample, or a clinical sample.
   152. The apparatus of any prior Aspect, wherein the filling factor is 2.3% or higher.
   153. The apparatus of any prior Aspect, wherein the thickness of one of the plates times the Young's modulus of the plate is in the range 100 to 550 GPa-μm.
   154. The apparatus of any prior Aspect, wherein the apparatus further comprises a measurement apparatus, wherein the measurement apparatus detects and/or quantifies the analyte by measuring an optical signal related to the analyte, wherein the optical signal comprising light reflection, scattering, transmission, absorption, spectrum, color, emission, intensity, wavelength, location, polarization, luminescence, fluorescence, electroluminescence, chemiluminescence, electrochemiluminescence, or any combination of thereof.
   155. The apparatus of any prior Aspect, wherein at least one of the plates is transparent.
   156. The apparatus of any prior Aspect, wherein at least one of the plates is made from a flexible polymer.
   157. The apparatus of any prior Aspect, wherein, the apparatus further comprises a detector that is an electrical detector for detecting an electric signal, wherein the electrical detector comprises comprising electrodes on one or both plates.
   158. The apparatus of any of any prior Aspect, wherein the flexible plate has a thickness in the range of 10 μm to 200 μm.
   159. The apparatus of any prior Aspect, wherein the variation is less than 30%.
   160. The apparatus of any prior Aspect, wherein the variation is less than 10%.
   161. The apparatus of any prior Aspect, wherein the variation is less than 5%.
   162. The apparatus of any prior Aspect, wherein the first and second plates are connected and are configured to be changed from the open configuration to the closed configuration by folding the plates.
   163. The apparatus of any prior Aspect, wherein the first and second plates are connected by a hinge and are configured to be changed from the open configuration to the closed configuration by folding the plates along the hinge.
   164. The apparatus of any prior Aspect, wherein the first and second plates are connected by a hinge that is a separate material to the plates, and are configured to be changed from the open configuration to the closed configuration by folding the plates along the hinge.
   165. The apparatus of any prior Aspect, wherein the first and second plates are made in a single piece of material and are configured to be changed from the open configuration to the closed configuration by folding the plates.
   166. The apparatus of any prior Aspect, wherein the layer of uniform thickness sample is uniform over a lateral area that is at least 1 mm².
   167. The apparatus of any prior Aspect, wherein the apparatus further comprises a dry reagent coated on one or both of the plates, wherein the reagent is selected from the group consisting of an antibody, a nucleic acid, cell stain, a dye, a protein, a releasable dry reagent, a labeled reagent, a fluorescently-labeled reagent, a dye, a bead, a quantum dot, the capture agent, detection agent, and blocking agent, light signal enhancers, light signal quenchers, and a fluorescently-labeled antibody.
   168. The apparatus of any prior Aspect, wherein at the closed configuration, the final sample thickness apparatus is configured to analyze the sample in 60 seconds or less.
   169. The apparatus of any prior Aspect, wherein at the closed configuration, the final sample thickness apparatus is configured to analyze the sample in 10 seconds or less.
   170. The apparatus of any prior Aspect, wherein the dry binding site comprises a capture agent.
   171. The apparatus of any prior Aspect, wherein the dry binding site comprises an antibody or nucleic acid.
   172. The apparatus of any prior Aspect, wherein the releasable dry reagent is a labeled reagent.
   173. The apparatus of any prior Aspect, wherein the releasable dry reagent is a fluorescently-labeled reagent.
   174. The apparatus of any prior Aspect, wherein the releasable dry reagent is a fluorescently-labeled antibody.
   175. The apparatus of any prior Aspect, wherein the releasable dry reagent is a cell stain.
   176. The apparatus of any prior Aspect, wherein the detector is an optical detector that detects an optical signal.
   177. The method and apparatus of any prior Aspect, wherein the spacers have a shape of pillars and a ratio of the width to the height of the pillar is equal or larger than one.
   178. The apparatus of any prior Aspect, wherein the detector is an electric detector that detect electrical signal.
   179. The apparatus of any prior apparatus Aspect, wherein the spacers are fixed on a plate by directly embossing the plate or injection molding of the plate.
   180. The apparatus of any prior apparatus Aspect, wherein the materials of the plate and the spacers are selected from polystyrene, PMMA, PC, COC, COP, or another plastic.
   181. The system of any prior system Aspect, wherein one of the plates has a binding site that binds an analyte, wherein at least part of the uniform sample thickness layer is over the binding site, and is substantially less than the average lateral linear dimension of the binding site.
   182. The system of any prior system Aspect, further comprising:
a housing configured to hold the sample and to be mounted to the mobile communication apparatus.
   183. The system of any prior system Aspect, wherein the housing comprises optics for facilitating the imaging and/or signal processing of the sample by the mobile communication apparatus, and a mount configured to hold the optics on the mobile communication apparatus.
   184. The system of any prior system Aspect, wherein an element of the optics in the housing is movable relative to the housing.
   185. The system of any prior system Aspect, wherein the mobile communication apparatus is configured to communicate test results to a medical professional, a medical facility or an insurance company.
   186. The system of any prior system Aspect, wherein the mobile communication apparatus is further configured to communicate information on the test and the subject with the medical professional, medical facility or insurance company.
   187. The system of any prior system Aspect, wherein the mobile communication apparatus is further configured to communicate information of the test to a cloud network, and the cloud network process the information to refine the test results.
   188. The system of any prior system Aspect, wherein the mobile communication apparatus is further configured to communicate information of the test and the subject to a cloud network, the cloud network process the information to refine the test results, and the refined test results will send back the subject.
   189. The system of any prior system Aspect, wherein the mobile communication apparatus is configured to receive a prescription, diagnosis or a recommendation from a medical professional.
   190. The system of any prior system Aspect, wherein the mobile communication apparatus is configured with hardware and software to:
(a) capture an image of the sample;
(b) analyze a test location and a control location in in image; and
(c) compare a value obtained from analysis of the test location to a threshold value that characterizes the rapid diagnostic test.
   191. The system of any prior system Aspect, wherein at least one of the plates comprises a storage site in which assay reagents are stored.
   192. The system of any prior system Aspect, at least one of the cameras reads a signal from the CROF apparatus.
   193. The system of any prior system Aspect, wherein the mobile communication apparatus communicates with the remote location via a Wi-Fi or cellular network.
   194. The method for analyzing an analyte in a sample, wherein the method comprises:
(a) obtaining a sample;
(b) obtaining a first and second plates that are movable relative to each other into different configurations, wherein each plate has a sample contact surface that is substantially planar, one or both plates are flexible, and one or both of the plates comprise spacers that are fixed with a respective sample contacting surface, and wherein the spacers have:
   i. a predetermined substantially uniform height of 200 μm or less,
   ii. a shape of pillar with a substantially flat top surface;
   iii. a predetermined constant inter-spacer distance;
   iv. the fourth power of the inter-spacer-distance (ISD) divided by the thickness of the flexible plate (h) and the Young's modulus (E) of the flexible plate, ISD⁴/(hE), is equal to or less than 10⁶ μm³/GPa; and
   v. the thickness of the flexible plate times the Young's modulus of the flexible plate is in the range 60 to 750 GPa-μm.
(c) depositing the sample on one or both of the plates when the plates are configured in an open configuration, wherein the open configuration is a configuration in which the two plates are either partially or completely separated apart and the spacing between the plates is not regulated by the spacers;
(d), after (c), bringing the two plates together into a closed configuration; in which: at least part of the sample forms into a layer of substantially uniform thickness that is confined by the sample contact surfaces of the plates, wherein the uniform thickness of the layer is regulated by the spacers and the plates; and
(e) analyzing the in the layer of uniform thickness while the plates are the closed configuration;
wherein the filling factor is the ratio of the spacer contact area to the total plate area.
   195. The method, apparatus or system of any prior Aspect, wherein the analyte comprises a molecule (e.g., a protein, peptides, DNA, RNA, nucleic acid, or other molecule), cells, tissues, viruses, and nanoparticles with different shapes.
   196. The method, apparatus or system of any prior Aspect, wherein the analyte comprises white blood cell, red blood cell and platelets.
   197. The method, apparatus or system of any prior Aspect, wherein the analyte comprises white blood cells differential assay.
   198. The method of any prior method Aspect, wherein the method comprises:
analyzing the results at the remote location to provide an analyzed result; and
communicating the analyzed result from the remote location to the mobile communication apparatus.
   199. The method of any prior method Aspect, wherein the analysis is done by a medical professional at a remote location.
   200. The method of any prior method Aspect, wherein the mobile communication apparatus receives a prescription, diagnosis or a recommendation from a medical professional at a remote location.
   201. The method, apparatus or system of any prior Aspect, wherein the sample is a bodily fluid.
   202. The method, apparatus or system of any prior Aspect, wherein the bodily fluid is blood, saliva, breath, or urine.
   203. The method, apparatus or system of any prior Aspect, wherein the sample is whole blood without dilution by another liquid.
   204. The method of any prior method Aspect, wherein the assaying step comprises detecting an analyte in the sample.
   205. The method of any prior method Aspect, wherein the analyte is a biomarker.
   206. The method of any prior method Aspect, wherein the analyte is a protein, nucleic acid, cell, or metabolite.
   207. The method of any prior method Aspect, wherein the method comprises counting the number of red blood cells.
   208. The method of any of any prior method Aspect, wherein the method comprises counting the number of white blood cells.
   209. The method of any prior method Aspect, wherein method comprises staining the cells in the sample and counting the number of neutrophils, lymphocytes, monocytes, eosinophiles and basophils.
   210. The method of any prior method Aspect, wherein the assay done in step (b) is a binding assay or a biochemical assay.
   211. A method for analyzing a sample comprising:
obtaining a apparatus of any prior apparatus or system Aspect;
depositing the sample onto one or both pates of the apparatus;
placing the plates in a closed configuration and applying an external force over at least part of the plates; and
analyzing the in the layer of uniform thickness while the plates are the closed configuration.
   212. The apparatus or method of any Aspects, wherein the method comprises:
(a) obtaining a sample;
(b) obtaining a first and second plates that are movable relative to each other into different configurations, wherein each plate has a sample contact surface that is substantially planar, one or both plates are flexible, and one or both of the plates comprise spacers that are fixed with a respective sample contacting surface, and wherein the spacers have:
   i. a predetermined substantially uniform height,
   ii. a shape of pillar with a flat top surface;
   iii. a ratio of the width to the height equal or larger than one;
   iv. a predetermined constant inter-spacer distance that is in the range of 10 μm to 200 μm;
   vi. the Young's modulus of the spacers times the filling factor of the spacers is equal or larger than 20 MPa, wherein the filling factor is the ratio of the spacer contact area to the total plate area; and
   vii. the filling factor is 2.3% or higher, and
(c) depositing the sample on one or both of the plates when the plates are configured in an open configuration, wherein the open configuration is a configuration in which the two plates are either partially or completely separated apart and the spacing between the plates is not regulated by the spacers;
(d), after (c), bringing the two plates together into a closed configuration; in which: at least part of the sample forms into a layer of substantially uniform thickness that is confined by the sample contact surfaces of the plates, wherein the uniform thickness of the layer is regulated by the spacers and the plates; and
(e) analyzing the in the layer of uniform thickness while the plates are the closed configuration;
wherein the filling factor is the ratio of the spacer contact area to the total plate area.
   213. The apparatus or method of any Aspects, wherein the method comprises
removing the external force after the plates are in the closed configuration; and
imaging the blood cells in the layer of uniform thickness while the plates are the closed configuration; and
counting a number of blood cells in an area of the image.
   214. The apparatus or method of any Aspects, wherein the inter-spacer distance is in the range of 20 μm to 120 μm.
   215. The apparatus or method of any Aspects, the fourth power of the inter-spacer-distance (ISD) divided by the thickness of the flexible plate (h) and the Young's modulus (E) of the flexible plate, ISD⁴/(hE), is equal to or less than 10⁶ μm³/GPa; and the thickness of one of the plates times the Young's modulus of the plate is in the range 100 to 550 GPa-μm.
   216. The apparatus or method of any Aspects, wherein the thickness of one of the plates times the Young's modulus of the plate is in the range 100 to 550 GPa-μm.
   217. The method, apparatus or system of any prior Aspect, the surface variation is less than 30 nm.
   218. The method, apparatus or system of any prior Aspect, wherein the sample is undiluted whole blood into which no anticoagulant has been added.
   219. The apparatus or method of any Aspects, wherein the depositing step (b) is done by:
pricking the skin of a human release a droplet of blood onto the skin and ii. contacting the droplet of blood with one or both of the plates without use of a blood transfer tool.
   220. The apparatus or method of any Aspects, wherein the analyzing step comprise counting the number of red blood cells.
   221. The method, apparatus or system of any prior Aspect, wherein the apparatus further comprise a scale makers, wherein the scale markers comprise at least a pair of the scale-markers are separated by a known distance that is parallel to a plane of the lateral area.
   222. The apparatus or method of any Aspects, wherein the analyzing step comprise staining the cells in the sample and counting the number of neutrophils, lymphocytes, monocytes, eosinophils and basophils.
   223. The apparatus or method of any Aspects, wherein the imaging and counting is done by:
i. illuminating the cells in the layer of uniform thickness;
ii. taking one or more images of the cells using a CCD or CMOS sensor;
iii. identifying cells in the image using a computer; and
iv. counting a number of cells in an area of the image.
   224. The apparatus or method of any Aspects, further comprising measuring sodium, potassium, chloride, bicarbonate, blood urea, nitrogen, magnesium, creatinine, glucose, calcium, HDL cholesterol LDL cholesterol levels and/or triglyceride levels in the layer of uniform thickness.
   225. The apparatus or method of any Aspects, wherein it future comprises a dry reagent coated on one or both plates.
   226. The apparatus or method of any Aspects, wherein the layer of uniform thickness sample has a thickness uniformity of up to +/−5%.
   227. The apparatus or method of any Aspects, wherein the spacers are pillars with a cross-sectional shape selected from round, polygonal, circular, square, rectangular, oval, elliptical, or any combination of the same.
   228. The apparatus or method of any Aspects, wherein the spacing between the spacers is approximately the average thickness of RBCs.
   229. The apparatus or method of any Aspects, wherein the analyzing step comprises imaging cells in the blood.
   230. The apparatus or method of any Aspects, wherein the comprises red blood cells, while blood cells, or platelets.
   231. The apparatus or method of any Aspects, wherein the analyzing the blood comprises imaging cancer cells, viruses, or bacteria in the blood.
   232. The apparatus or method of any Aspects, wherein the analyzing the blood comprises detecting of proteins or nucleic acids.
   233. The apparatus or method of any Aspects, wherein the analyzing the blood comprises measuring of hemocytes, comprising determining of the sample thickness using the spacer, determining the lateral area by imaging, and calculating the area of red blood cells using the 2D image.
   234. The apparatus or method of any Aspects, wherein the analyzing the blood comprises measuring of red cell concentration in the blood.
   235. The apparatus or method of any Aspects, wherein the analyzing the blood comprises measuring of white blood cell concentration in the blood.
   236. The apparatus or method of any Aspects, wherein the analyzing the blood comprises measuring of platelet concentration in the blood.
   237. The apparatus of any prior Aspect, wherein the sample is a blood, the analytes are blood cells, and the uniform thickness of the layer is 1.9 μm-2.2 μm.
   238. The method, apparatus, or system of any prior Aspect, wherein the pressing is by human hand.
   239. The method, apparatus, or system of any prior Aspect, wherein the pressing is by human hand, and the uniform sample thickness has a variation of 50% or less.
   240. The method, apparatus, or system of any prior Aspect, wherein at least a portion of the inner surface of one plate or both plates is hydrophilic.
   241. The method, apparatus, or system of any prior Aspect, wherein the sample is a deposition directly from a subject to the plate without using any transferring apparatus.
   242. The method, apparatus, or system of any prior Aspect, wherein after the sample deformation at a closed configuration, the sample maintains the same final sample thickness, when some or all of the compressing forces are removed.
   243. The method, apparatus, or system of any prior Aspect, wherein the spacers have pillar shape and nearly uniform cross-section.
   244. The method and apparatus of any prior Aspect, wherein the fourth power of the inter-spacer-distance (ISD) divided by the thickness (h) and the Young's modulus (E) of the flexible plate (ISD⁴/(hE)) is 5×10⁶ μm³/GPa or less.
   245. The method and apparatus of any prior Aspect, wherein the fourth power of the inter-spacer-distance (ISD) divided by the thickness (h) and the Young's modulus (E) of the flexible plate (ISD⁴/(hE)) is 5×10⁵ μm³/GPa or less.
   246. The method and apparatus of any prior Aspect, wherein the spacers have pillar shape, a substantially flat top surface, a predetermined substantially uniform height, and a predetermined constant inter-spacer distance that is at least about 2 times larger than the size of the analyte, wherein the Young's modulus of the spacers times the filling factor of the spacers is equal or larger than 2 MPa, wherein the filling factor is the ratio of the spacer contact area to the total plate area, and wherein, for each spacer, the ratio of the lateral dimension of the spacer to its height is at least 1 (one).
   247. The method and apparatus of any prior Aspect, wherein the spacers have pillar shape, a substantially flat top surface, a predetermined substantially uniform height, and a predetermined constant inter-spacer distance that is at least about 2 times larger than the size of the analyte, wherein the Young's modulus of the spacers times the filling factor of the spacers is equal or larger than 2 MPa, wherein the filling factor is the ratio of the spacer contact area to the total plate area, and wherein, for each spacer, the ratio of the lateral dimension of the spacer to its height is at least 1 (one), wherein the fourth power of the inter-spacer-distance (ISD) divided by the thickness (h) and the Young's modulus (E) of the flexible plate (ISD⁴/(hE)) is 5×10⁶ μm³/GPa or less; wherein the sample is blood; wherein the analytes is red blood cell, white blood cell, or platelets; and wherein the uniform thickness of the layer is in a range of 1.8 μm to 2.6 μm.
   248. The method, apparatus or system of any prior Aspect, wherein the analytes is the analyte in a detection of proteins, peptides, nucleic acids, synthetic compounds, and inorganic compounds.
   249. The method, apparatus, or system of any prior Aspect, wherein the sample that is deposited on one or both of the plates has an unknown volume.
   250. The method, apparatus, or system of any prior Aspect, wherein the sample is for the detection, purification and quantification of chemical compounds or biomolecules that correlates with the stage of certain diseases.
   251. The method, apparatus, or system of any prior Aspect, wherein the samples is related to infectious and parasitic disease, injuries, cardiovascular disease, cancer, mental disorders, neuropsychiatric disorders, pulmonary diseases, renal diseases, and other and organic diseases.
   252. The method, apparatus, or system of any prior Aspect, wherein the sample is related to the detection, purification and quantification of microorganisms.
   253. The method, apparatus, or system of any prior Aspect, wherein the sample is related to virus, fungus and bacteria from environment, e.g., water, soil, or biological samples.
   254. The method, apparatus, or system of any prior Aspect, wherein the samples is related to the detection, quantification of chemical compounds or biological samples that pose hazard to food safety or national security, e.g., toxic waste, anthrax.
   255. The method, apparatus, or system of any prior Aspect, wherein the samples is related to quantification of vital parameters in medical or physiological monitor.
   256. The method, apparatus, or system of any prior Aspect, wherein the samples is related to glucose, blood, oxygen level, total blood count (red blood cells, white blood cells, or platelets).
   257. The method, apparatus, or system of any prior Aspect, wherein the samples are related to the detection and quantification of specific DNA or RNA from biosamples.
   258. The method, apparatus, or system of any prior Aspect, wherein the samples are related to the sequencing and comparing of genetic sequences in DNA in the chromosomes and mitochondria for genome analysis.
   259. The method, apparatus, or system of any prior Aspect, wherein the samples are related to detect reaction products, e.g., during synthesis or purification of pharmaceuticals.
   260. The method, apparatus, or system of any prior Aspect, wherein the samples are cells, tissues, bodily fluids, and stool.
   261. The method, apparatus, or system of any prior Aspect, wherein the sample is the sample in the detection of proteins, peptides, nucleic acids, synthetic compounds, inorganic compounds.
   262. The method, apparatus, or system of any prior Aspect, wherein the sample is the sample in the fields of human, veterinary, agriculture, foods, environments, and drug testing.
   263. The method, apparatus, or system of any prior Aspect, wherein the sample is a biological sample is selected from blood, serum, plasma, a nasal swab, a nasopharyngeal wash, saliva, urine, gastric fluid, spinal fluid, tears, stool, mucus, sweat, earwax, oil, a glandular secretion, cerebral spinal fluid, tissue, semen, vaginal fluid, interstitial fluids derived from tumorous tissue, ocular fluids, spinal fluid, a throat swab, breath, hair, finger nails, skin, biopsy, placental fluid, amniotic fluid, cord blood, lymphatic fluids, cavity fluids, sputum, pus, microbiota, meconium, breast milk, exhaled condensate nasopharyngeal wash, nasal swab, throat swab, stool samples, hair, finger nail, ear wax, breath, connective tissue, muscle tissue, nervous tissue, epithelial tissue, cartilage, cancerous sample, or bone.
   264. The method, apparatus, or system of any prior Aspect, wherein the sample is blood.
   265. The method, apparatus, or system of any prior Aspect, wherein the sample is a biological sample, an environmental sample, a chemical sample, or clinical sample.

We claim:

1. An apparatus for assaying an analyte in multiple samples, comprising:
a cartridge to receive a sample, wherein the cartridge comprises a first plate and a second plate that are movable relative to each other into different configurations, including an open configuration and a closed configuration;
a transporter to position and advance the cartridge;
a first dispenser to deposit a sample on one of the two plates of the cartridge when the cartridge is at the open configuration;
a press to compress the first and second plates of the cartridge from the open configuration to the closed configuration, making the sample between the first and second plates into a uniformly thick layer; and
an imager to image the uniformly thick layer;
wherein one or both of the two plates are flexible; each plate has, on its respective surface, a sample contact area for contacting the sample; and one or both of the two plates comprise spacers that are fixed with a respective plate;
wherein the spacers have pillar shape and a predetermined uniform height of 200 μm or less, and a predetermined inter-spacer distance, and wherein at least one of the spacers is inside the sample contact area;
wherein the open configuration is the configuration, in which: the two plates are separated apart, the spacing between the plates is not regulated by the spacers, and the sample is deposited on one or both of the plates; and
wherein the closed configuration is the configuration, which is configured after the sample deposition in the open configuration; and in the closed configuration: at least part of the sample is compressed by the two plates into a layer of uniform thickness and is substantially stagnant relative to the plates, wherein the uniform thickness of the layer is confined by the inner surfaces of the two plates and is regulated by the plates and the spacers.

2. The apparatus of claim 1, further comprising a cartridge feeder to place the cartridge on the transporter.

3. The apparatus of claim 1, further comprising a second dispenser to dispense a reagent to contact the sample.

4. The apparatus of claim 1, wherein the reagents are coated on one or both of the two plates.

5. The apparatus of claim 1, wherein the fourth power of the inter-spacer-distance (ISD) divided by the thickness of the flexible plate (h) and the Young's modulus (E) of the flexible plate, ISD4/(hE), is equal to or less than 5×10⁶ μm³/GPa; and the thickness of the flexible plate times the Young's modulus of the flexible plate is in the range 60 to 750 GPa-μm.

6. The apparatus of claim 1, further comprising a docking apparatus to position the cartridge in a stationary position.

7. The apparatus of claim 1, wherein the docking apparatus positions the cartridge in the stationary position in the fourth station.

8. The apparatus of claim 1, wherein the first and second plates are connected by a hinge and are configured to be changed from the open configuration to the closed configuration by folding the plates along the hinge.

9. The apparatus of claim 1, wherein the first and second plates are not connected by a hinge.

10. A method of executing an assay, comprising:
placing a cartridge on a transporter with the cartridge in an open configuration;
depositing a sample on the cartridge with a first dispenser;
closing, using a press, the first plate and the second plate of the cartridge into a closed configuration, make the sample between the first and second plates into a uniformly thick layer;
imaging the sample at the closed configuration with an imager to obtain an image; and
analyzing the image with an analyzer to determine a property of the sample.

11. The method of claim 10, wherein:
the base layer is formed in a first station;
the sample is deposited on the cartridge in a second station;
the reagent and sample are contacted in the second station;
the cover layer and the assay card are formed in a third station; and
the sample is imaged in a fourth station.

12. The method of claim 10, further comprising positioning the cartridge in a stationary position prior to imaging the sample.

13. The method of claim 10, wherein the cartridge is positioned in the stationary position in the fourth station.

14. The method of claim 10, further comprising docking the cartridge in a stationary position prior to imaging with a docking apparatus.

15. The method of claim 10, further comprising moving the cartridge in a horizontal or linear direction during imaging with a moveable stage.

16. The apparatus of claim 1, wherein:
the cartridge comprises a spacer fixed to a sample contact area of the cartridge;
the spacer includes a pillar shape, a substantially flat top surface, a predetermined substantially uniform height and a predetermined inter-space distance;
the inter-spacer distance is a distance between two neighboring spacers;
a Young's modulus of the spacer multiplied by the filling factor of the spacer is equal to or larger than 2 MPa; and
the filling factor is the ratio of a spacer contact area to a total cartridge area.

17. The apparatus of claim 1, further comprising a docking apparatus to position the cartridge in a stationary position.

18. The apparatus of claim 1, wherein the docking apparatus comprises a mechanical arm.

19. The apparatus of claim 1, further comprising a moveable stage for moving the cartridge in a horizontal and vertical direction.

20. The apparatus of claim 19, wherein the moveable stage comprises a motorized stage.
